(19) United States
(12) Patent Application Publication
(10) Pub. No.: US 2016/0048606 A1
(43) Pub. Date: Feb. 18, 2016

(54) Methods, Systems, Apparatus, Products, Articles and Data Structures for Cross-Platform Digital Content

(71) Applicant: KISS DIGITAL MEDIA PTY LTD., Monbulk, Victoria (AU)

(72) Inventors: Asher Rubinstein, North Caulfield (AU); Oliver Krasny, Brighton (AU); Ivo Jager, Monbulk (AU); Renee Fulton, Monbulk (AU)

(21) Appl. No.: 14/784,041

(22) PCT Filed: Apr. 12, 2014
(86) PCT No.: PCT/AU2014/000415

§ 371 Date: Oct. 13, 2015

(30) Foreign Application Priority Data
Apr. 13, 2013 (AU) 2013901280

(51) Int. Cl. G06F 17/30; G06F 17/22; G06F 17/24

(52) U.S. Cl. CPC G06F 17/30899; G06F 17/243; G06F 17/2247

(57) ABSTRACT

The present invention relates to handling of digital content in cross-platform environments and provides methods, systems, computer readable storage with instructions, and/or products for providing digital content, including the possibility of portions of the content being accessible over a communication network. In one form, the invention provides a functional software product compliant with a predetermined computing platform adapted for cross-platform use that may include: a predetermined form means for presenting content to a user of the product, a predetermined function means for enabling the user of the product to navigate content, and at least one driver means operatively associated with the functional software product for enabling access to content by the predetermined form and function means wherein the driver means is adapted for accessing at least one originating content data resource having a format non-specific to the predetermined computing platform.

### RELATED APPLICATIONS

This application claims priority to Australian Provisional Patent Application No. 2013901280 in the name of Kiss Digital Media Pty Ltd, which was filed on 13 Apr. 2013, entitled “System and Method for Cross-Platform Content Creation and Playback” and the specification thereof is incorporated herein by reference in its entirety and for all purposes.

### FIELD OF INVENTION

The present invention generally relates to handling of digital content in a cross-platform or multi-platform environment. In preferred forms, the present invention provides methods, systems, computer readable storage with instructions, and/or products for providing digital content, e.g., content for digital media, platforms and services in the form of a website, computer-executable application, a web application, a smart phone application, a social media profile page, an e-mail newsletter, a DVD menu, etc., including the possibility of portions of the content being accessible over a communication network.

It will be convenient to hereinafter describe the invention in relation to computer-implemented means for creation, storage, distribution, playback and/or rendering of digital content in a medium-, platform-, service- and distribution-independent manner, however it should be appreciated that the present invention is not limited to that application, only.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related or prior art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Since the advent of multiple forms of mass-media such as newspapers, radio and television, it has been the case that brands, businesses, governments and even individuals, have been forced to broadcast their message, regardless of its contents, in different forms suitable to these different media, in order to reach the largest audience possible.

More recently, the amount of media forms that these entities can choose to broadcast their message on has expanded significantly with the advent of new platforms of digital communication media such as websites, social media, apps, e-mail and other interactive media. The latter developments have arguably had a fragmenting effect on the media landscape, while the sometimes ephemeral nature of the popularity of some of these platforms, for example, social media platforms or smartphone operating systems, has made targeted investment in these platforms a risky and costly proposition in terms of return on investment (ROI).

In contrast, often the message-content of some of the older, more established or conservative entities in the media landscape has remained the same. By way of example, Vegemite™—“it puts a rose in every cheek™”, DeBeers™—“Diamonds are forever™”, Nike™—“Just Do It™”, are all examples of entities with an unchanged message and content that spans multiple generations. Yet, while their message for broadcasting and disseminating has not changed, these entities have had to adapt and continually invest in the ever changing and fragmenting media landscape in order to gain a foothold on the increasing amount of new media platforms as their audiences adopt them. The pace of required adaptation has arguably accelerated over the past few years with the introduction of the aforementioned digital media, platforms and services.

As a result, it has become evident that more and more investment is required in order to bring the same old or consistent message and content to every new medium, platform or service.

It has also become evident that obsolescence or demise of a medium, platform or service, whether it is in the examples of Betamax™, CD-i™, PalmOS™, Bebo™, or MySpace™, may unfortunately coincide with the obsolescence of the message and content on that medium or service, completely negating the efforts expended and investments made.

It would therefore be considered desirable to address the future-proofing of digital content, to reduce the financial risk (in terms of ROI) with bringing one's content to a digital medium, platform or service, and to more cost-effectively cover past, present and future digital media, platforms and services.

Additionally, current attempts at providing the same content on multiple digital media, platforms or services fail to take into account the unique uses and user gratifications that drove the adoption of each individual digital medium, platform or service in the first place. In this respect, the term ‘gratifications’ is used as reference to the user preferred application level features of software products. The result is that current solutions of prior art known to the inventor attempt to ‘shoe-horn’ content for the lowest common denominator digital medium, platform or service onto other platforms. This is typically done by standardizing on one single technology (for example web technology or Adobe™ Flash™) that goes on to define the content, form, function and distribution mechanism for all digital media, platforms and services—past, present and future—that the system is to encompass.

An example of such prior art is the great number of on-line smartphone app builders which standardize on web technology because web technology is platform-independent and the same web app can be deployed on any medium, platform or service that supports the rendering of web content. A clear downside is that the ‘apps’ are nothing more than lowest common denominator websites and are devoid of any form or functionality that capitalizes on the unique capabilities that the host medium, platform or service can provide. Additionally, content distribution is limited to a one-to-many client-server approach with a single repository of the content.

Another example of such prior art is the proprietary multimedia and software platform of Adobe™ Flash™, briefly mentioned above, which adopts a one-size-fits-all approach, where different platforms render the exact same content in the exact same way in the exact same form with the exact same functionality, by means of a player that is created for each platform. The commercial failure of Adobe™ Flash™ on mobile platforms (such as Android™), can be summarised briefly as follows. It never caught on because it was too slow to run on smartphone hardware, suffered from low frame rates and lagging response in its application to the Android™ platform and the drain on battery was too much. More importantly, it did not take into account hardware fragmentation and assumed certain screen aspect ratios and screen density/DPI. As a result graphics and controls were too small and would not fill the whole screen. Its design and architecture simply was not flexible enough to render interactive content well on different devices with different screen sizes, different hardware and that were designed for different modalities/contexts of use. For example, devices that fit in your pocket, have smaller amounts of memory and/or have smaller amounts of CPU power and/or have smaller amounts of screen ‘real estate’ and/or run off a battery power source. This therefore highlights the need to take into account the unique capabilities, uses and gratifications of each target platform.

Furthermore, where prior art systems have tried to address making available cross-platform content, these solutions have typically not been able to resolve the mixing and matching of different distribution mechanisms, and have not been able to define a universal model by which the content can be navigated across any and all platforms, media and services.

Additionally, governments and organisations around the world are continuously looking for ways to enhance accessibility of their content in order to make their content available to, for example, the vision impaired. Currently, separate efforts and investments are required to create and disseminate content in order to target these audiences via alternative media.

Traditional publishing houses too are still grappling with the shift to digital media and monetization thereof. A single solution to render content effectively on different platforms and different media, and providing enhanced functionality, dynamic updates and Digital Rights Management (DRM) around their content where possible, has thus far been elusive with the prior art available.

It is therefore desired to address or ameliorate one or more disadvantages or limitations associated with the prior art, or to at least provide a useful alternative.

### SUMMARY OF INVENTION

In a first aspect of embodiments described herein there is provided a functional software product compliant with a predetermined computing platform adapted for cross-platform use comprising: a predetermined form means for presenting content to a user of the product; a predetermined function means for enabling the user of the product to navigate content, and; at least one driver means operatively associated with the functional software product for enabling access to content by the predetermined form and function means wherein the driver means is adapted for accessing at least one originating content data resource having a format non-specific to the predetermined computing platform.

The at least one driver means may comprise: translation means for translating platform specific data access requests of the functional software product into platform independent data access requests.

Preferably, the platform specific data access requests and the platform independent data access requests comprise one or a combination of: read requests and; write requests.

Preferably, the at least one driver means is adapted to expose one or more aggregated archives of originating content data resources to the predetermined form and function means to search each archive for an associated URI of the archive resource to be retrieved.

Preferably, the at least one driver means resides within an application level of the software product.

In another aspect of embodiments described herein there is provided a data structure for use in accessing a content archive, said data structure comprising information stored in a memory used by an application adapted for viewing and/or rendering resources located in the content archive wherein the information comprises: an array of data resulting from an iteration through pointers to URI's of each resource located in the content archive wherein a hierarchy of each resource is implicitly declared in its associated URI.

Preferably, the implicitly declared hierarchy of the URI when used by the application adapted for viewing and/or rendering content resources comprises nodes adapted for one or a combination of: providing associated content for search engine optimisation; providing at least one hint instruction for processing by an associated software product adapted for viewing and/or rendering the content in compliance with a predetermined computing platform wherein the hint instruction enables the software product to optimize the rendering of the content in accordance with the viewing and/or rendering resources of the software product.

The data structure may comprise a hash table.

In yet another aspect of embodiments described herein there is provided a system for handling digital content on a plurality of predetermined computing platforms, the system comprising: a functional software product compliant with a first predetermined computing platform having computer readable program code and computer readable system code embodied on a non-transitory computer useable medium for presenting content to a user of the product and enabling the user of the product to navigate content within a data processing system; at least one driver means adapted for accessing at least one originating content data resource having a format non-specific to the first predetermined computing platform.

Preferably, the at least one driver means comprises translation means operatively associated with the functional software product for translating platform specific data access requests of the functional software product into platform independent data access requests. The content may be contained in at least two or more data storage archives.

Preferably, at least two or more data storage archives comprise a data file format that provides asymmetric performance in respect of reading and writing functions in which reading has precedence and priority. The at least two or more data storage archives may be located on one or a combination of: an Internet server; CD-ROM; RAM; Smartphone resource bundle; External hardrive.

The system may further comprise: union mounting means adapted to union mount the content of the at least two or more data storage archives to produce an aggregate of content accessible to the user of the software product.

Preferably, the system further comprises at least one driver means adapted for writing to at least one of the at least two or more data storage archives.

In still another aspect of embodiments described herein there is provided a method for handling digital content on a plurality of predetermined computing platforms comprising the steps of: presenting content to a user of a functional software product compliant with a first predetermined computing platform and enabling the user of the product to navigate content within a data processing system; accessing at least one originating content data resource having a format non-specific to the first predetermined computing platform.

Preferably, the method further comprises the steps of: union mounting the content of at least two or more data storage archives to produce an aggregate of content accessible to the user of the software product.

In yet another aspect of embodiments described herein there is provided a method of forming an aggregate of at least two originating content archives stored in compliance with differing respective predetermined computing platforms to form a single cross-platform accessible archive for use in one or more predetermined computing platforms, the method comprising the steps of: union mounting the content resources of the at least two originating content archives to provide a single aggregated archive available to the functional software product such that the content resources of the most recently mounted of the at least two originating content archives takes precedence for access.

Preferably, the method further comprises the step of: masking at least one or more content resources from the functional software product to emulate a deletion of the one or more resources.

In still yet another aspect of embodiments described herein there is provided a method of retrieving an archive resource for use in a functional software product compliant with a predetermined computing platform, the method comprising the steps of: exposing each of a plurality of originating content archives of an aggregated archive formed in accordance with the method as claimed in claim 18 or 19 by to a functional software product by accessing the at least one content archive with a corresponding driver means operatively associated with the functional software product; sequentially searching each archive for an associated URI of the archive resource to be retrieved; returning the archive resource to the functional software product upon locating the associated URI.

Preferably, the step of sequentially searching comprises the steps of: opening each originating content archive of the aggregated archive in order of newest first; determining if the URI of the archive resource to be retrieved is either existing in the searched originating content archive or masked.

Preferably, the method further comprises the step of applying access control to the step of exposing wherein the access control corresponds to user privileges.

In yet a further aspect of embodiments described herein there is provided a method of storing content resources comprising a header and data contents in at least one archive, the method comprising the step of: allocating attributes to each resource header, the attributes comprising at least a URI for the resource wherein a hierarchy of the content resource is implicitly provided within the URI.

Preferably, the method further comprises the steps of: providing an offset table in the at least one archive; for each content resource allocating an offset table entry in the offset table for pointing to an offset located in a digital data storage corresponding to the header of the content resource.

In preferred embodiments of the invention there is provided a content archive comprising content resources stored in accordance with the above disclosed methods.

In yet a further aspect of embodiments described herein there is provided a method of rendering a content resource in more than one predetermined computing platform, the method comprising the steps of: accessing a content resource stored in accordance with the methods disclosed herein in one or more archives, each archive compliant with one or more predetermined computing platforms; expanding a root node in the hierarchy of URI of the content resource; rendering the content associated with the root node; expanding at least one further node in the hierarchy of URI of the content resource; rendering the content associated with the at least one further node; determining from the content rendered in each rendering step if the expanded node has children or parent nodes and rendering the content of each determined child or parent node. Preferably the steps of rendering comprise one or a combination of:

displaying;
navigating;
providing a means for navigating; and,
providing a means for displaying.

Preferably, at least one node is provided with a hint instruction for processing by an associated software product adapted for rendering the content in compliance with a predetermined computing platform wherein the hint instruction enables the software product to optimize the rendering of the content in accordance with the rendering resources of the software product.

Preferred embodiments of the invention provide apparatus adapted to handle digital content on a plurality of predetermined computing platforms, said apparatus comprising: processor means adapted to operate in accordance with a predetermined instruction set, said apparatus, in conjunction with said instruction set, being adapted to perform the methods of handling digital content on a plurality of predetermined computing platforms herein disclosed.

Preferred embodiments of the invention provide a computer program product comprising: a non-transient computer usable medium having computer readable program code and computer readable system code embodied on said medium for handling digital content on a plurality of predetermined computing platforms within a data processing system, said computer program product including: computer readable code within said computer usable medium for performing the methods handling digital content on a plurality of predetermined computing platforms disclosed herein.

Preferred embodiments of the invention provide apparatus adapted to form an aggregate of at least two originating content archives stored in compliance with differing respective predetermined computing platforms to form a single cross-platform accessible archive for use in one or more predetermined computing platforms, said apparatus comprising: processor means adapted to operate in accordance with a predetermined instruction set, said apparatus, in conjunction with said instruction set, being adapted to perform the method to form an aggregate of at least two originating content archives stored in compliance with differing respective predetermined computing platforms to form a single cross-platform accessible archive for use in one or more predetermined computing platforms as disclosed herein.

Preferred embodiments of the invention provide a computer program product comprising: a non-transient computer usable medium having computer readable program code and computer readable system code embodied on said medium for forming an aggregate of at least two originating content archives stored in compliance with differing respective predetermined computing platforms to form a single cross-platform accessible archive for use in one or more predetermined computing platforms within a data processing system, said computer program product including: computer readable code within said computer usable medium for performing the method for forming an aggregate of at least two originating content archives stored in compliance with differing respective predetermined computing platforms to form a single cross-platform accessible archive for use in one or more predetermined computing platforms disclosed herein.

Preferred embodiments of the invention provide apparatus adapted to retrieve an archive resource for use in a functional software product compliant with a predetermined computing platform, said apparatus comprising: processor means adapted to operate in accordance with a predetermined instruction set, said apparatus, in conjunction with said instruction set, being adapted to perform the methods to retrieve an archive resource for use in a functional software product compliant with a predetermined computing platform as disclosed herein.

Preferred embodiments of the invention provide a computer program product comprising: a non-transient computer usable medium having computer readable program code and computer readable system code embodied on said medium for retrieving an archive resource for use in a functional software product compliant with a predetermined computing platform within a data processing system, said computer program product including: computer readable code within said computer usable medium for performing the methods for retrieving an archive resource for use in a functional software product compliant with a predetermined computing platform as disclosed herein.

Preferred embodiments of the invention provide apparatus adapted to store content resources comprising a header and data contents in at least one archive, said apparatus comprising: processor means adapted to operate in accordance with a predetermined instruction set, said apparatus, in conjunction with said instruction set, being adapted to perform the method storing content resources comprising a header and data contents in at least one archive as disclosed herein.

Preferred embodiments of the invention provide a computer program product comprising: a non-transient computer usable medium having computer readable program code and computer readable system code embodied on said medium for storing content resources comprising a header and data contents in at least one archive within a data processing system, said computer program product including: computer readable code within said computer usable medium for performing the methods of storing content resources comprising a header and data contents in at least one archive as disclosed herein.

Preferred embodiments of the invention provide apparatus adapted to render a content resource in more than one predetermined computing platform, said apparatus comprising: processor means adapted to operate in accordance with a predetermined instruction set, said apparatus, in conjunction with said instruction set, being adapted to perform the method to render a content resource in more than one predetermined computing platform as disclosed herein.

Preferred embodiments of the invention provide a computer program product comprising: a non-transient computer usable medium having computer readable program code and computer readable system code embodied on said medium for rendering a content resource in more than one predetermined computing platform within a data processing system, said computer program product including: computer readable code within said computer usable medium for performing the method for rendering a content resource in more than one predetermined computing platform as disclosed herein.

In essence, the present invention stems from the realization that adopting an approach to handling digital content that separates content from the form and function of software/computing platforms with protocols and mechanisms other than at the Operating System level can provide for universal cross-platform distribution and navigation of content. In this respect, the use of driver means within the application level of a given platform specific software product for accessing originating content data archived in formats non-specific to the software product platform along with adaptation of a union mount function to the passive content to provide an effective layering in data storage enables the aggregation of originating content resources to provide an updateable digital content resource that avoids encumbrances inherent to cross-platform distribution, whereas use of a hierarchical model for the content resources that is inherently or implicitly residing within the URI of each resource in conjunction with a means for rendering that content with instructional hints provided by nodes in the hierarchy that correspond to the platform-specific rendering and functional capabilities of the platform-specific software product, which allows for the rendering and navigation of digital content that is not platform dependent.

Other aspects and preferred forms are disclosed in the specification and/or defined in the appended claims, forming a part of the description of the invention.

Advantages provided by the present invention comprise the following:
A strict separation of content form and function brings security benefits for example, a website may no longer store content intermixed with resources and code that define form and function and therefore no longer uses any underlying file system directly from the point of view of the rendering application. This makes it easier to protect content from vulnerabilities in past, present and future resources that would otherwise potentially expose access to or harboring of potentially malicious code. In this way, the separation of content from form and function liberates content from any platform-specific encumbrances.
The union mount/layering of multiple archives liberates a functional software product for users from restrictive distribution practices and enables use to ‘update’/override content in highly restricted environments. Effectively, the use of a mechanism analogous to a union mount allows for updating content that is in first instance read-only (for example in a application resource bundle) if other means of getting content to the device are available.
The use of a hierarchical data model allows the generation of compelling ‘mash ups’ of content that can meet a certain standard of richness (or sparseness).
The granularity stemming from the way resources are hierarchically related allows for the creation of very rich, or very sparse views of the content as desired, allowing content to be effectively rendered and navigated across a great range of devices and form factors.
The use of hints helps specific platforms render content in more optimal ways. The usage of hints allows for platform specific form or functionality without impeding the cross-platform portability of content.
The inherent granularity and contextual parent/child relationship of the content that the hierarchy affords, allows for effective machine readability and algorithmically distilling meaning from the content for SEO and keyword generation purposes.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 is a block diagram of three component aspects for building a software product for a digital medium in accordance with prior art;

FIG. 1A is a block diagram of the three component aspects for building a software product for a digital medium in accordance with prior art of FIG. 1 and how these aspects are implemented in the case of a traditional website driven by a CMS (Content Management System) like WordPress™, Drupal™ or Joomla™;

FIG. 1B is a block diagram of the three component aspects of FIG. 1 for building a software product for a digital medium in accordance with prior art and how these aspects are implemented in the case of a traditional Android™ or iOS™ smartphone app;

FIG. 1C is a block system diagram illustrating the use of exemplary drivers substituted for platform dependent content handling entities and procedures as depicted in FIGS. 1A and 1B in accordance with a preferred embodiment of the present invention to provide a platform independent distribution of content.

FIG. 1D is a block diagram of the three component aspects of FIG. 1B for building a software product for a digital medium in accordance with prior art and illustrating a means of content access implemented in the case of a traditional Android™ or iOS™ smartphone app;

FIG. 1E is a block diagram of the three component aspects for building a software product for a digital medium in accordance with prior art of FIG. 1A and illustrating a means of content access implemented in the case of a traditional website driven by a CMS (Content Management System) like WordPress™, Drupal™ or Joomla™;

FIG. 2 is a block diagram illustrating how multiple archives for content storage are mounted to combine and form an updateable aggregate content archive in accordance with embodiments of the present invention;

FIG. 3 is a block diagram showing an example of a content hierarchy utilized in accordance with a preferred embodiment of the present invention;

FIG. 3a is a block diagram showing an example of the content hierarchy of FIG. 3 with one whole branch omitted;

FIG. 3b is a block diagram showing an example of the content hierarchy of FIG. 3a with one whole branch added by means of overlaying a new archive in accordance with a preferred embodiment of the present invention;

FIG. 3c is a block diagram showing an example of the content hierarchy of FIG. 3 with a single text content resource updated by means of overlaying a new archive in accordance with a preferred embodiment of the present invention;

FIG. 4 is a flow chart describing how URIs (Unique Resource Identifiers) are located across multiple archives in accordance with an embodiment of the present invention;

FIG. 4a is a flow chart illustrating the process of locating URI's as in FIG. 4 but with access control included in accordance with a preferred embodiment of the present invention;

FIG. 5 is a flow chart describing a simple implementation of navigation for a viewer in accordance with an embodiment of the present invention;

FIG. 6 illustrates an example of hierarchical content created in accordance with an embodiment of the present invention and shown from different depths of the hierarchy rendered by a viewer;

FIG. 6A illustrates another example of hierarchical content created in accordance with an embodiment of the present invention and shown from different depths of the hierarchy rendered by a viewer;

FIG. 7 illustrates an example of a user interface for selection of a node in the hierarchy of content created in accordance with an embodiment of the present invention;

FIG. 7A illustrates an example of a user interface for selection of a node in the hierarchy of content created in accordance with an embodiment of the present invention, where in this example a user has selected the item ‘rodent control’ in the interface depicted in FIG. 7;

FIG. 8 illustrates an example of a simple archive file format implementation used in accordance with preferred embodiments of the present invention;

FIG. 9 is a block diagram illustrating an example of a preferred embodiment of the invention as implemented on the Google™ Android™ platform;

FIG. 9a is a block diagram illustrating an example of a preferred embodiment of the invention on the Google™ Android™ platform, where a second archive is added via three distinct distribution mechanisms;

FIG. 10 is a block diagram illustrating an example of a preferred embodiment of the invention as implemented on a webserver;

FIG. 10a is a block diagram illustrating an example of a preferred embodiment of the invention as implemented on a webserver, where content is updated by a third party or Content Management System;

FIG. 11 is a block diagram illustrating an example of a preferred embodiment of the invention implemented as a Facebook pagetab;

FIG. 12 is a block diagram illustrating an example of a preferred embodiment of the invention implemented as an Interactive Voice Response (IVR) system;

FIG. 13 is a block diagram of an exemplary computing architecture or system configured with a CPU, one or more different types of storage memories, a random access memory, a user input module and an output model that is suitable for a generic version of a software product in accordance with a preferred embodiment of the present invention;

FIG. 13a is a block diagram of an exemplary computing architecture or system configured with a CPU, a storage memory, a random access memory, a user input module and an output model for implementing a software product in accordance with a preferred embodiment of the present invention that is suitable for distribution via a ‘walled garden’ app store;

FIG. 13b is a block diagram of a computing architecture or system configured with a CPU, a storage memory, a random access memory, along with a networked client terminal containing input and output modules, that is suitable for rendering the content as web site or application in accordance with an embodiment of the present invention.

### DETAILED DESCRIPTION

A digital content storage, distribution and access system in the form of an embodiment of the present invention is described hereinbelow.

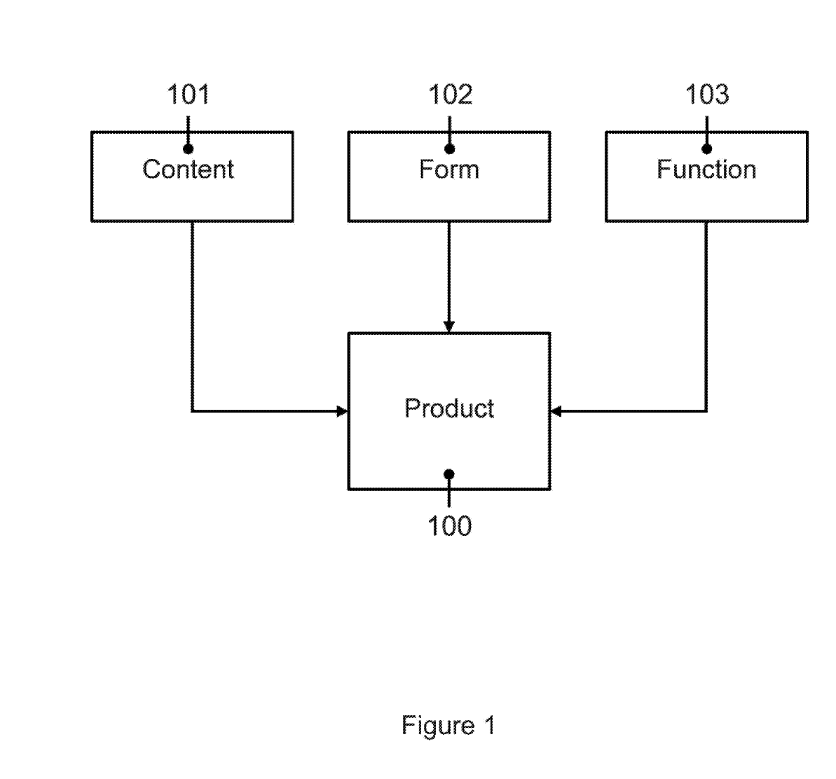

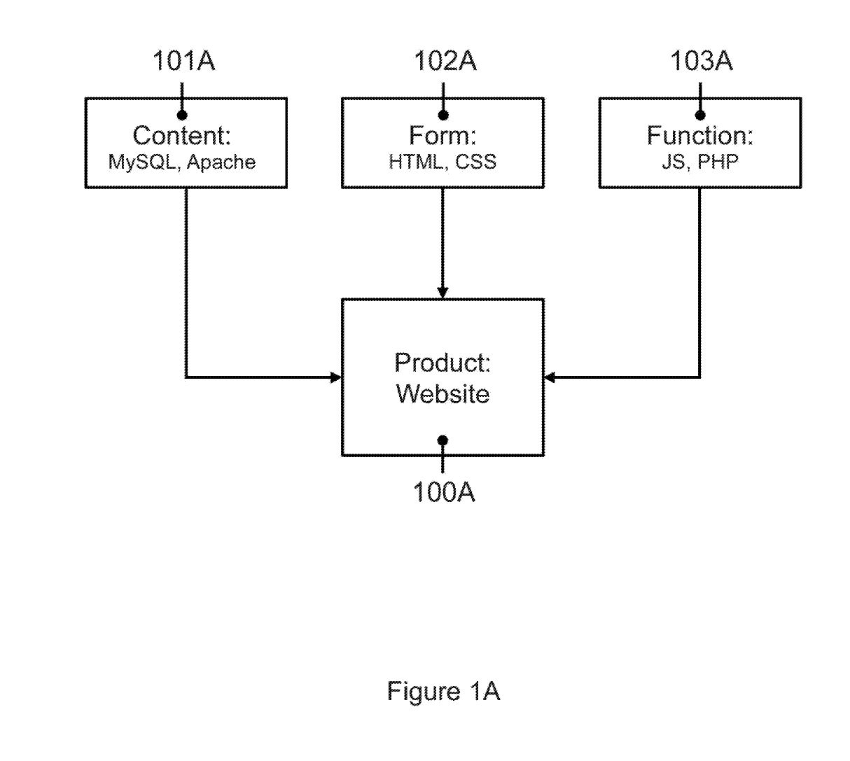

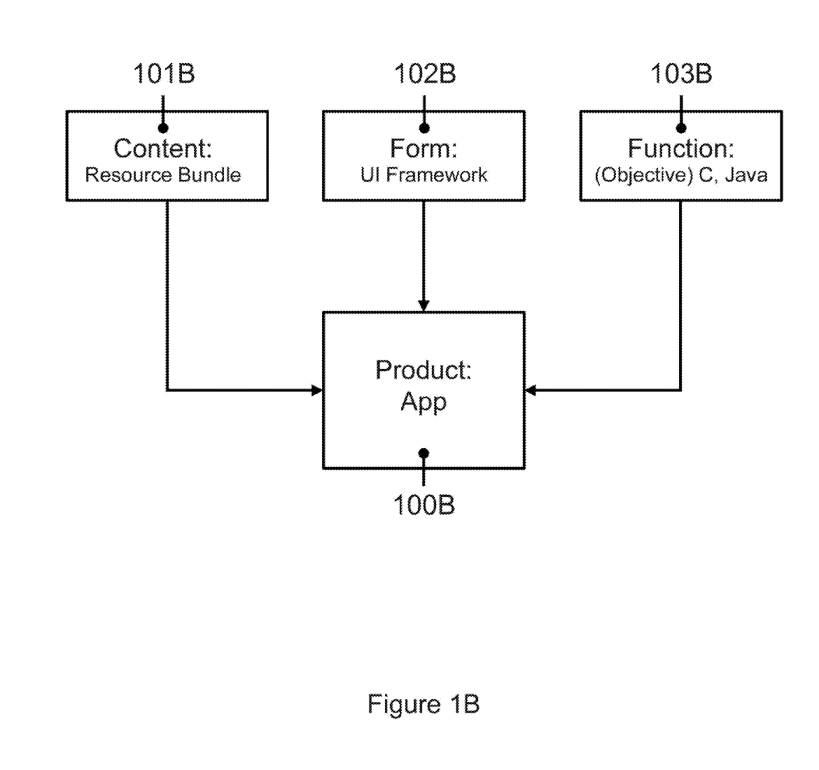

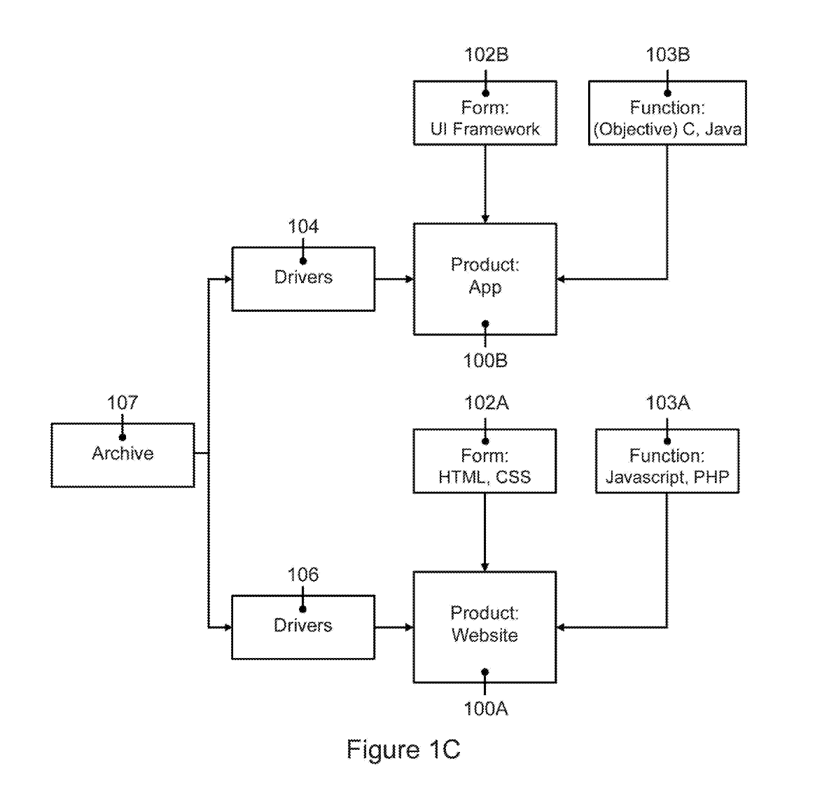

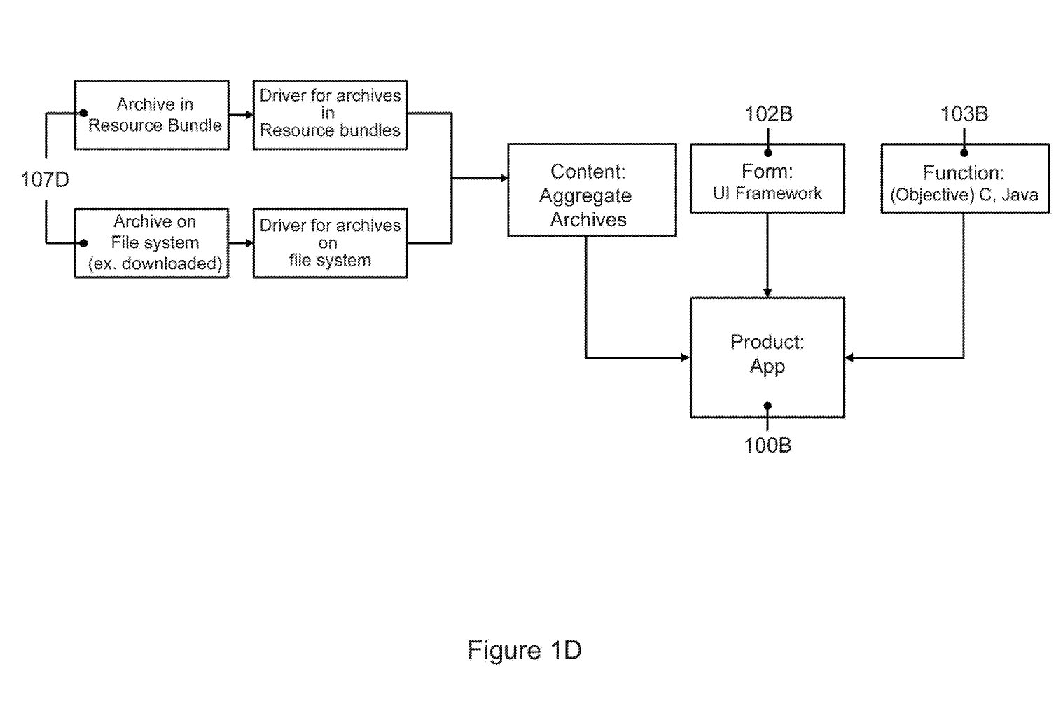

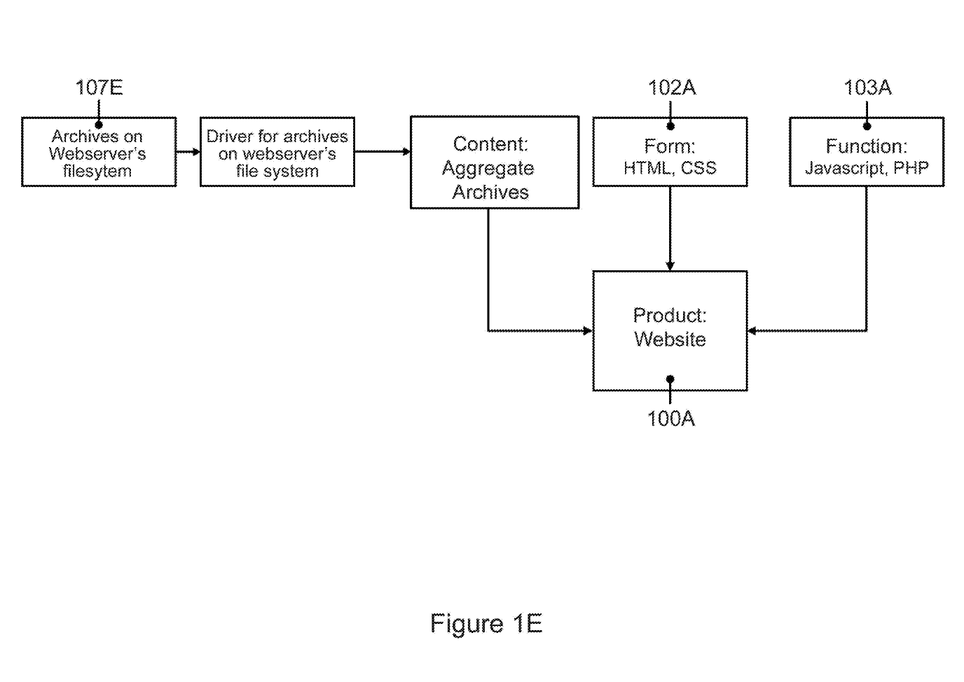

Referring to FIG. 1, there is shown in separate illustration three component aspects that comprise a functioning software product for embodiment on a digital medium, platform or service.

Element 101, ‘Content’, in FIG. 1 generically signifies the means and technology by which content is stored and subsequently accessed by the user. This content 101 can be stored, for example, in a MySQL database, an application resource bundle, or any of a variety of prior art file systems such as FAT16, FAT32, NTFS, EXT4, etc.

Element 102, ‘Form’, in FIG. 1 generically signifies the means and technology by which the content 101 is presented to the user. The content 101 can be presented, for example, in a website, in a smartphone app, in an audio channel, or as an overlay in an augmented reality environment.

Element 103, ‘Function’, in FIG. 1 generically signifies the means and technology by which the content 101 is navigated and perused. The content 101 can be navigated and perused, for example, by browsing images using a touchscreen interface, by handing off a phone number to a phone application in order to call it on capable platforms, by using an in-built GPS unit to show a route to an address on capable platforms, by displaying any video clips on capable platforms, by playing any audio clips on capable platforms, by downloading any additional content on capable platforms, etc.

FIGS. 1A and 1B show examples of technologies which might be typically used to implement the three different component aspects discussed above on two entirely different platforms. The three aspects are noted with like numerals to that of FIG. 1 as 101A/B, 102A/B, 103A/B, respectively. FIG. 1A indicates the technologies which might typically be used to implement the three different aspects for a traditional website driven by a classic CMS (Content Management System) like Wordpress™, Drupal™ or Joomla™. FIG. 1B shows the technologies which might typically be used to implement the three different aspects in the case of a traditional Android™ or iOS™ smartphone app. Different implementation technologies may be employed for other mediums, services or platforms such as Facebook apps and pages, e-mail newsletters, Blackberry 10, Windows Phone 8, etc.

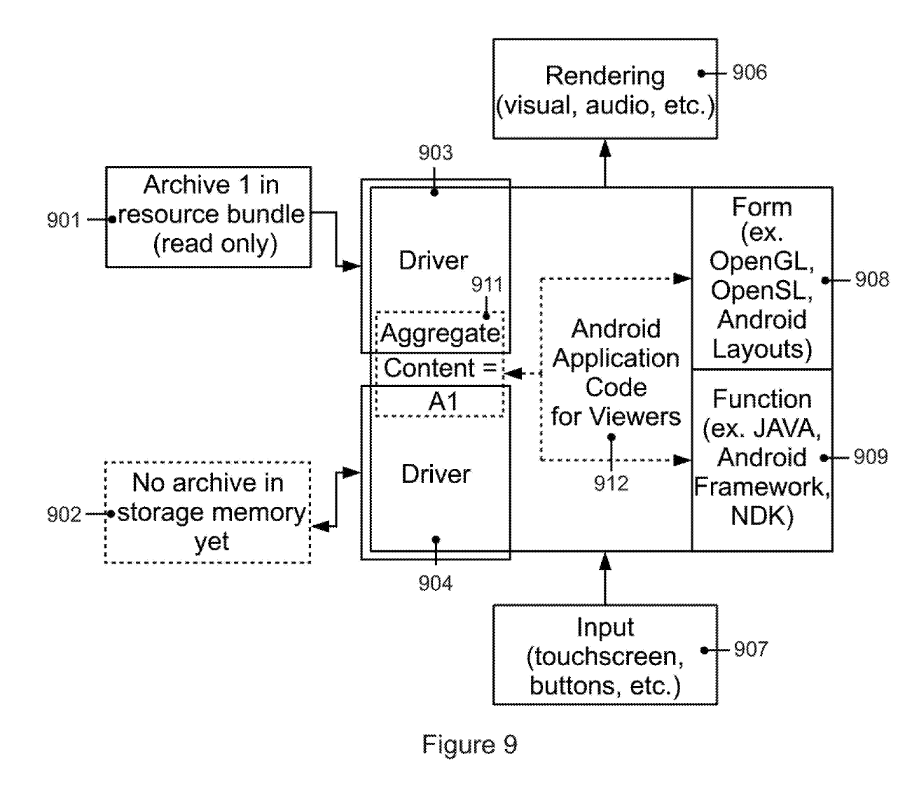

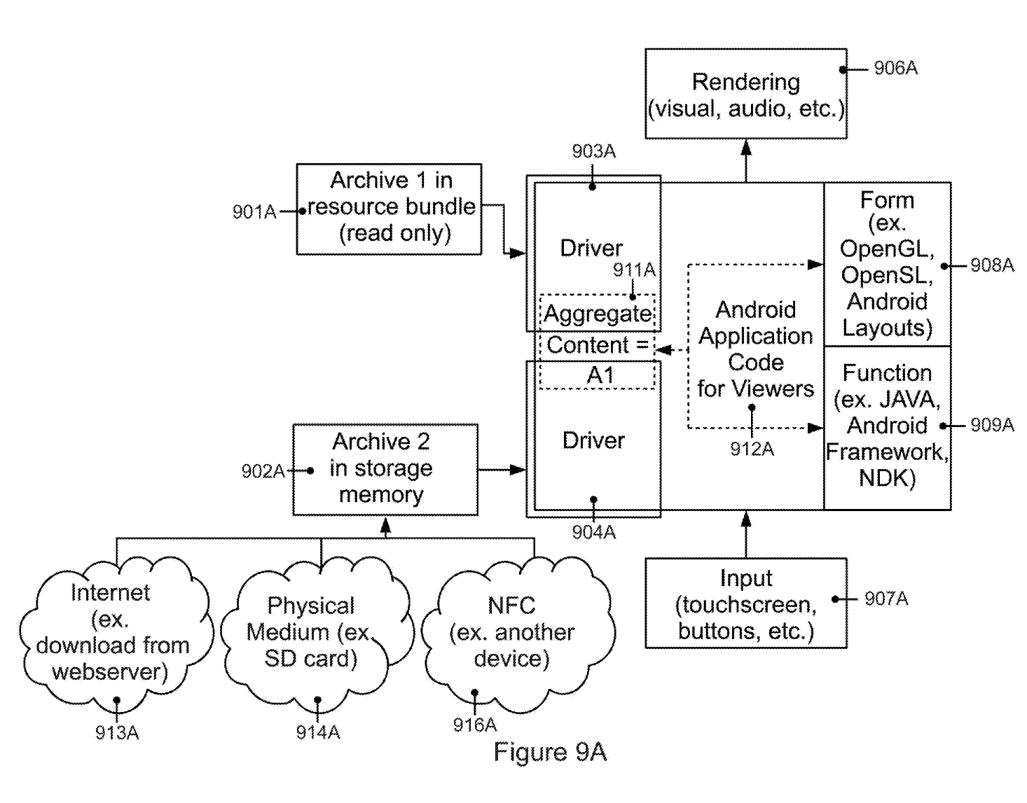

Embodiments of the present invention address the need for cross-platform content distribution that caters to any updateable originating digital content source, such as an originating archive of data 107 as shown in FIG. 1C, while acknowledging that in order to make full use of the capabilities of a medium, service or platform, the form 102 and function 103 aspects should exploit as much as possible a medium, service or platform's native technical capabilities and interface. This acknowledgement ensures the user experience stays true to the uses and gratifications that the medium, service or platform provides and that drove its adoption by the public in the first place. In this way, the content's availability is not a function of one single way of distributing the content. For example with reference to FIG. 9a, the content is distributable via physical media, a client-server architecture or, an ad-hoc device-to-device communication. In contrast, a prior art cross-platform content distribution solution such as for example from Contentful.com only works via client-server distribution of the content, limiting the way the content can be made available, shared and updated.

It is recognized that the former acknowledgement contrasts with prior art systems that provide cross-platform content which instead rely on a single technology to provide form 102, function 103 and content 101. For example, the embodiments of the present invention allow for a fully tailored medium, service or platform-specific experience, whereas technologies that fail to discern between the three aspects either limit the richness of the content 101 that a platform can provide or simply wrap another platform's content in a content player (for example Adobe™ Flash™ content played by Flash Player, or web content in a web view on a smartphone such as used by services like ShoutEm™, Appsmakerstore™, ShareableApps.com™).

It is also recognised that the content's location and distribution mechanism is typically restricted in prior art solutions. For example, in the case of a Wordpress™ website, a single version of the content resides in a database on the web server, which makes the content as a single entity non-distributable to, for example, local storage on a smartphone device. Similarly, a native app on, for example a smartphone, will have its content reside in local storage in a format, specific to that smartphone device. Its content cannot be immediately uploaded to a webserver without an API that puts the content's constituent resources in the right place in the webserver's database first. The block system diagrams of FIGS. 1D and 1E are illustrative of these example circumstances for smartphone and web environments, respectively. These different ways of storing content on different devices, media and services in most prior art solutions make one-to-one sharing of the content as a whole between different devices, media and platforms impractical at best and impossible at worst. Moreover, it is typically impossible in prior art solutions to mix and match distribution mechanisms and pieces of content.

FIG. 1C is a block diagram that illustrates how an embodiment of the present invention proposes to homogenize the content aspect of the three aspects that make up a functioning software product on a digital medium, platform or service, by implementing a single content source and format that works across all digital media, platforms and services. It does this by swapping out the medium, platform or service-specific content technology (the way content is stored and distributed for perusal in the application by the form and function) for a single content technology that is common for all media, services and platforms. This single content source is accessed on each medium, service or platform by means of a driver that translates any medium, platform or service-specific content read requests (and, where possible, write requests) into platform-independent content read requests (and, where possible, write requests). Preferably, this is performed by drivers. Whilst drivers may all necessarily be specific and/or different for each application and therefore the translation performed by each driver is different it would be understood by the person skilled in the art how an archive that resides in a storage area/medium—for all intents and purposes a ‘file’—may be exposed to the application. This is a platform-dependent procedure. It is then a matter of creating a translation layer that converts a read request from a certain location within the ‘file’ to a read request that performs that functionality in that platform-dependent way.

The embodiments described herein propose to that take into consideration separation of the content 101 from the other two aspects, namely form 102 and function 103, so that the two latter aspects may be implemented in such a way as to ensure the user experience stays true to the uses and gratifications that the medium, service or platform provides and which drove its adoption by the public in the first place.

It may also be noted that a strict separation of content, for example associated with archive 107, form 102 and function 103 brings security benefits: a website, for example, no longer stores content 101 intermixed with resources and code that define form 102 and function 103 and no longer uses any underlying file system directly from the point of view of the rendering application. This makes it easier to protect content from vulnerabilities in past, present and future resources that would otherwise potentially expose access to form 102 and function 103 related code. The impossibility of harboring (potentially malicious) code also has important implications for the acceptance of the content on gate-kept or restricted platforms such Apple's iOS™, which do not allow downloadable and/or unsigned code onto their platform.

It may further be noted that updating and modifying content in the single source 107 will be reflected immediately across all digital media, platforms and services where real-time access to the updated content is available and a one-to-many approach to content updates is desired, for example, through an on-line central repository where the content is managed.

Embodiments of the present invention also accommodate read-only and/or access-restricted environments where content is otherwise difficult to update. Examples of such environments are app stores such as Apple's App Store™ or Google's Play Store™ where it is (or has been) a requirement to submit the content 101 (in the form of an application resource bundle) along with the form 102 and function 102. This in order to satisfy the requirement that an app be self-contained, without having to rely on further network access to pull in any missing content. Such content can traditionally only be updated by re-submitting an updated app with an updated resource bundle that incorporates the new updates to the content.

In order to accomplish the apparent updating of the content, for example, that of a resource bundle, the present system uses a notion called ‘copy-on-write’ or ‘layering’ as found in some file system services (eg. UnionFS™) on some operating systems, which can be used to join one or multiple read-only and one or multiple write-only file systems, so that they appear as a single writable ‘union mount’ file system to the operating system.

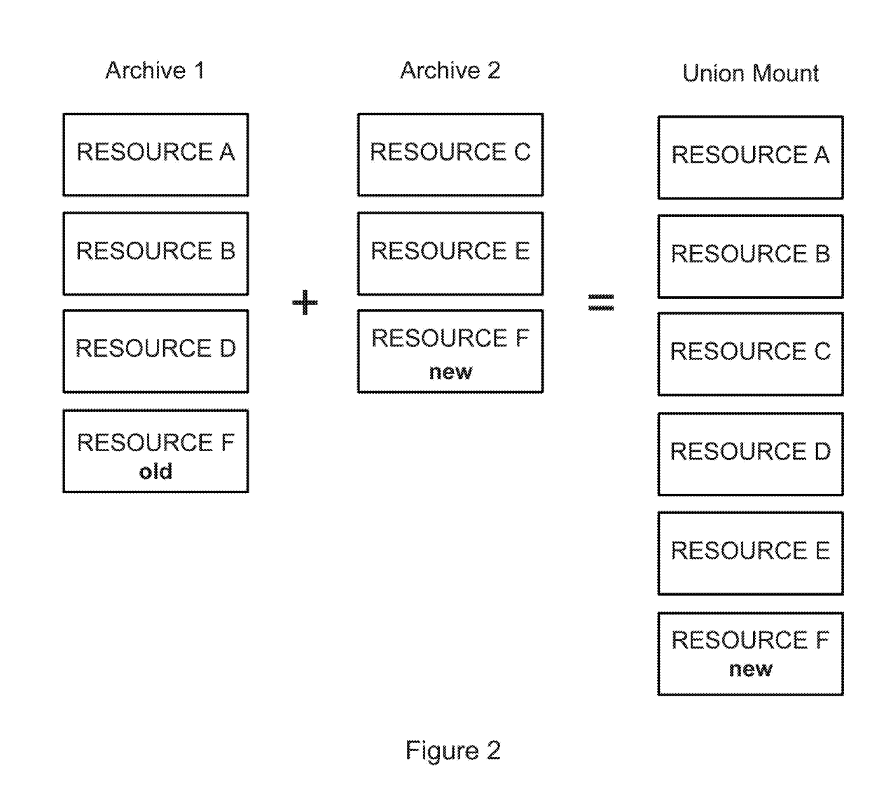

Embodiments of the present invention use an analogous mechanism to ‘union mounts’ in order to accomplish the updating of the renderable content of an otherwise read-only resource bundle. In contrast to ‘union mounts’ relating to file systems at an operating system level, embodiments of the present invention apply to mounting archives at the application level where, the archives themselves may possibly be residing on different storage solutions but not necessarily. Accordingly, in accordance with preferred embodiments of the invention a modified process for a union mount of archives is achieved by the following steps: The present system, in preferred embodiments, further allows chaining of one or more content archives in such a way that they together form a single content source (see FIG. 2 for example) analogous to a layered virtual file system. In the case of a single resource that exists in multiple archives, only the resource in the last chained content archive is considered. This effectively allows for updating ‘old’ read-only resources without physically deleting or overwriting them. Additionally, this mechanism allows for expansions to the original content. The sequence by which chaining is performed may be informed by, for example, a time stamp indicating which archive was oldest and should be mounted first, etc. Finally, this mechanism allows for ‘deleting’ resources by masking them out by overlaying an archive that explicitly encodes a ‘masked out’ flag for a specific URI.

In the context of this disclosure the term ‘URI’ is used as reference to the unique name which identifies a resource, or by means of a partial match, a collection of resources. By way of example, root/level0/level1/mypicture is the URI (or ‘file name’) of a resource which is in all likelihood containing a picture, while root/level0/level1/ is the URI (or ‘directory) of the node in the hierarchy where mypicture is located. Similarly, root/level0/level1/myvideo is the URI (or ‘file name’) of a resource which in all likelihood would contain a video, while again, root/level0/level1/ is the URI (or ‘directory) of the node in the hierarchy where myvideo is located. In other words ‘myvideo’ and ‘mypicture’ belong to the same node with the URI root/level0/level1/. In a preferred embodiment of the present invention a viewer evaluating the node at root/level0/level1/ will consider two resources for rendering; ‘mypicture’ and ‘myvideo’. A platform that can display both may display both. A platform that can only display the content of one resource, for instance, ‘mypicture’ may display only the picture.

The use of a mechanism analogous to a union mount greatly facilitates cross-platform distribution of the content. It helps get around a great number of encumbrances that are inherent to cross-platform distribution. To be as platform independent as possible, preferred embodiments of the present invention cater to as many different distribution mechanisms as possible and not just pick one, like most prior art, such as for example, a cloud-based client-server mechanism currently popular, one example of which is Contentful.com which states it to be “future proof” but may not be if the cloud connection requirement is considered. By using the union mount mechanism the embodiments of the present invention cater to distribution through, for example, App store-distributed read-only resource bundles, physical media, access via a network, download via a network, device-to-device/peer-to-peer ad-hoc network connections (e.g by bluetooth or NFC), etc.

FIG. 2 diagrammatically illustrates how multiple archives can form one monolithic content source denoted by ‘union mount’. Notice how the two archives appear combined in the ‘union mount’ and how the new ‘Resource F’ is visible, while old ‘Resource F’ is not.

It is important to note that, as opposed to a prior art file system service (such as UnionFS™) or a layered virtual file system (also known as a Z-axis File System or ZFS) that mounts different file systems or virtual layers to become a ‘union mount’, the present system mounts archives that are all in the same structured format, however themselves residing on some other type of managed storage solution (which may be, for example, another file system, a database, an application resource bundle, a HTML5 cache, or any contiguous block of random access memory), accessible to the application (for example a smartphone app, a webserver serving the content, a smart watch app, a Google Glass™ app, etc.) that the content is intended for. In other words, as opposed to prior art file systems, the present system makes do with whatever storage solution(s) the content serving and/or rendering application (not the underlying Operating System) can provide.

Therefore, embodiments of the present system circumvent the need for the server, medium or host to have a mountable or accessible file system at all—all that is needed for a server, medium or host to start providing read-access to an archive, is the exposure of a method to read data at a specified storage memory location within the archive, wherever the archive may be located. As opposed to prior art, the executable (or interpretable) code for the relevant driver that provides access to the storage memory (however that may be made accessible to the executable code) is contained in the platform-specific application (which is meant to render and/or serve the content) and, as opposed to prior art file systems, does not require system wide installation of drivers or kernel modules.

Note that the accessibility of the content may be exclusive to the application the content is intended for, in order to satisfy any sandbox model (or security model) of operation imposed on applications by, for example, an Operating System. The present system fully respects such restrictions.

Since, as opposed to the prior art, the contents of the union mount is strictly ‘passive’ content (due to its strict separation of form and function) and is only mountable by an application equipped with the right drivers (code of which is contained in the application for which the content is destined), no concept of an operating system is needed a priori. By design no executable code shall ever be included in the mounted archives (due to its sole intent of conveying content and not functionality or form related resources), so no operating system is required to be able to launch any code in the archive. This means that, where mandated, guarantees can be made that the archives are free of executable code.

These important attributes allow, for example, content updates on restricted or ‘walled garden’ platforms (such for example Apple's iOS™) that expose only limited ways to store additional content and that forbid any downloadable, unsigned or non-vetted executable code, let alone modifications to the operating system or the installation of device drivers and/or kernel modules. The content serving and/or rendering application itself (containing the code to mount any archives) however, can still be distributed by the same approved and tightly controlled means as before.

Simplicity of the procedure that is needed to read from an archive is key, both for ease of implementation of the application-level drivers across multiple platforms (not all of which may have large amounts of processing power at their disposal), as well as performance. In contrast, the procedure for writing resources into an archive is less of a consideration. This preferred asymmetry is due to the observation that the resources within digital content, as applied and used in the field of the present system, are typically read far more often than they are written, as opposed to prior art generic file systems where such predictions are typically hard to make. And because the present system does not concern a file system, but rather an analogous archive of files, which itself is transferred to (and from) some native data store as a whole at some stage during the content's distribution, transfer speed (and thus size) of the archive is an important consideration.

Therefore, a preferred embodiment of the present invention would implement a file format for the archive that is asymmetrical with regards to performance, efficiency and complexity when considering reading (where these considerations are important) and writing (where these considerations are less important). Significant read speed gains can be had over regular prior art general purpose file systems by dispensing with these prior art file systems' tendencies to optimize equally for both read and write access. For example, some prior art file systems may, as part of the file system, update a tree data structure containing files and directories as files are written, deleted and modified. Yet other prior art file systems explicitly create, manage and delete containers/directories in, for example, a hierarchical data structure as part of the file system. Yet other file systems keep track of free sectors or clusters and/or come with anti-fragmentation measures. For the sake of simplicity, a preferred embodiment of the present system may dispense with these mechanisms and additional data structures that would speed up write operations. Instead, a preferred embodiment of the present invention focuses on improving read speeds and transfer speed (both within the archive, as well as the archive itself). The present system may, in a preferred embodiment, for example, do this by making sure the data is tightly packed in the archive and never fragmented—something that is hard to do without sacrificing write speeds. In a preferred embodiment of the present invention, hierarchies (analogous to nested directories in prior art file systems) are implicitly declared by the URIs of the resources (for example by a slash, as is common on UNIX file systems, or some other delimiter token), rather than explicitly created by encoding directory or folder entries in some additional data structure. It is up to the application serving and/or rendering the content to decode the hierarchical relationships between resources from their individual URIs. The application serving and/or rendering is free to use whatever data structure it wishes to cache these relationships or otherwise optimize access times associated with fast location and reading of resources. However, the latter shall preferably not be a feature of the archive format itself, for the sake of compactness and simplicity of implementing a driver for reading.

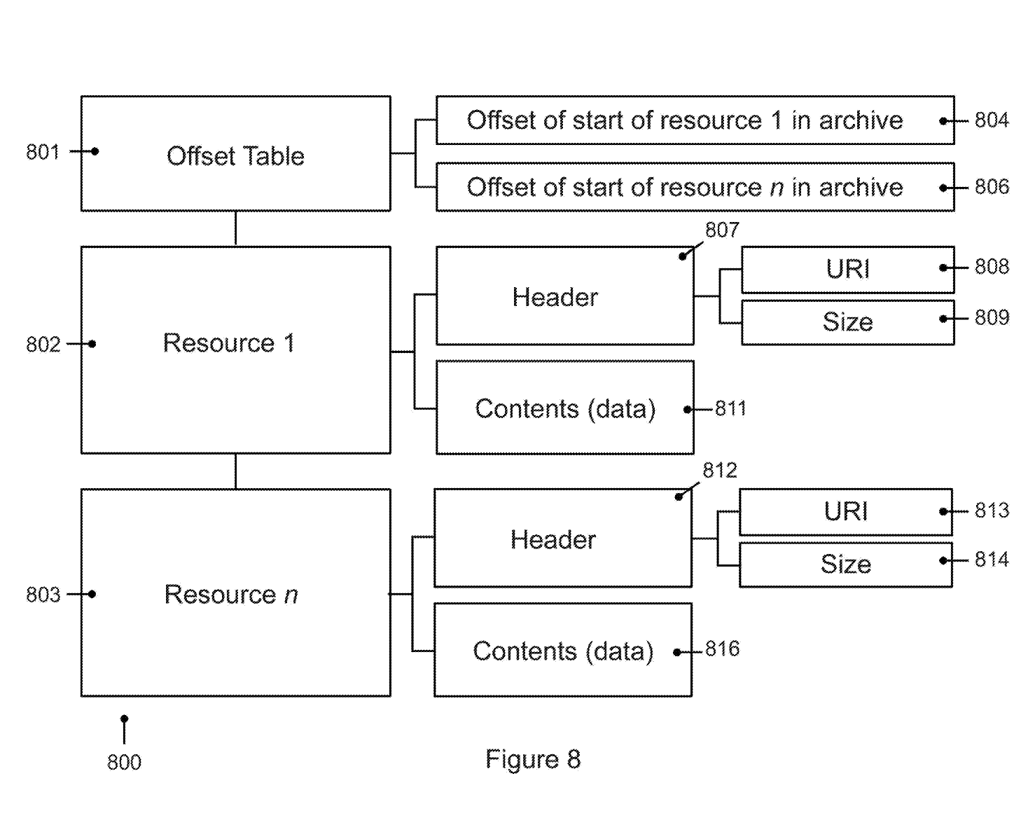

FIG. 8 illustrates a simple example of a possible file format 800 for an archive. An offset table 801 keeps an entry 804, 806 for each resource 802, 803 which points to the offset where a resource header begins. A resource header 807, 812 specifies some simple attributes, such as the resource Unique Resource Identifier 808, 813 and the actual size of the resource 809, 814. Finally, the resource's contents (data) 811, 816 is stored right after the header 807, 812. It would be apparent to one skilled in the art that this very simple format description suffices for a solution that sequentially stores a number of resources. It would also be apparent that a resource 802, 803 can be located within the archive by its URI 808, 813 by iterating through all the headers 807, 812 that all the offset table 801 entries points to. It is envisaged that doing this once for all resources and storing the results in memory in a data-structure (such as, for example, a hash table) can greatly speed up access times.

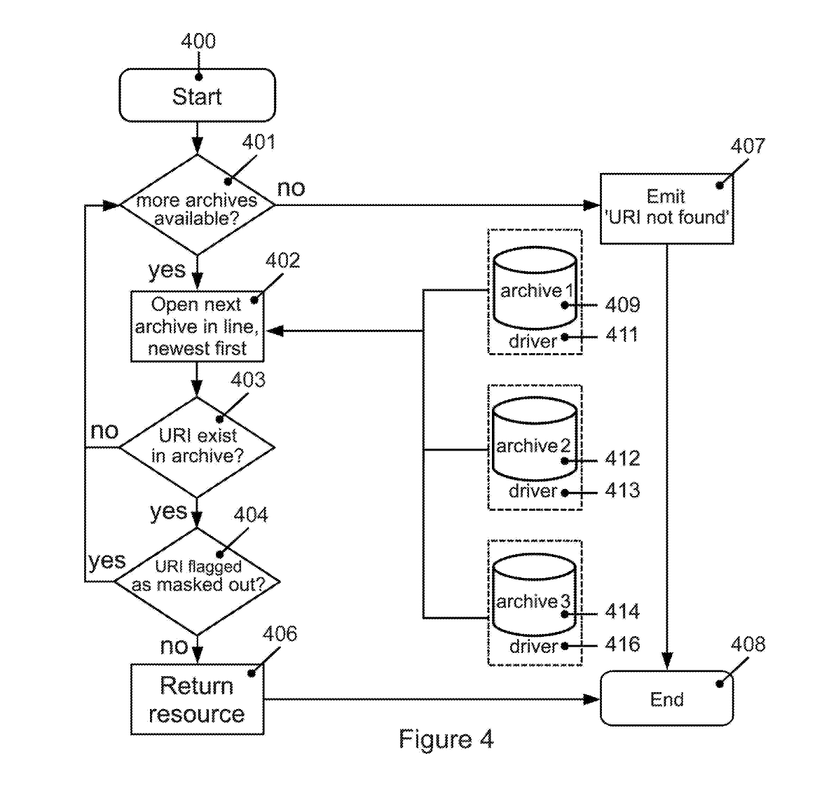

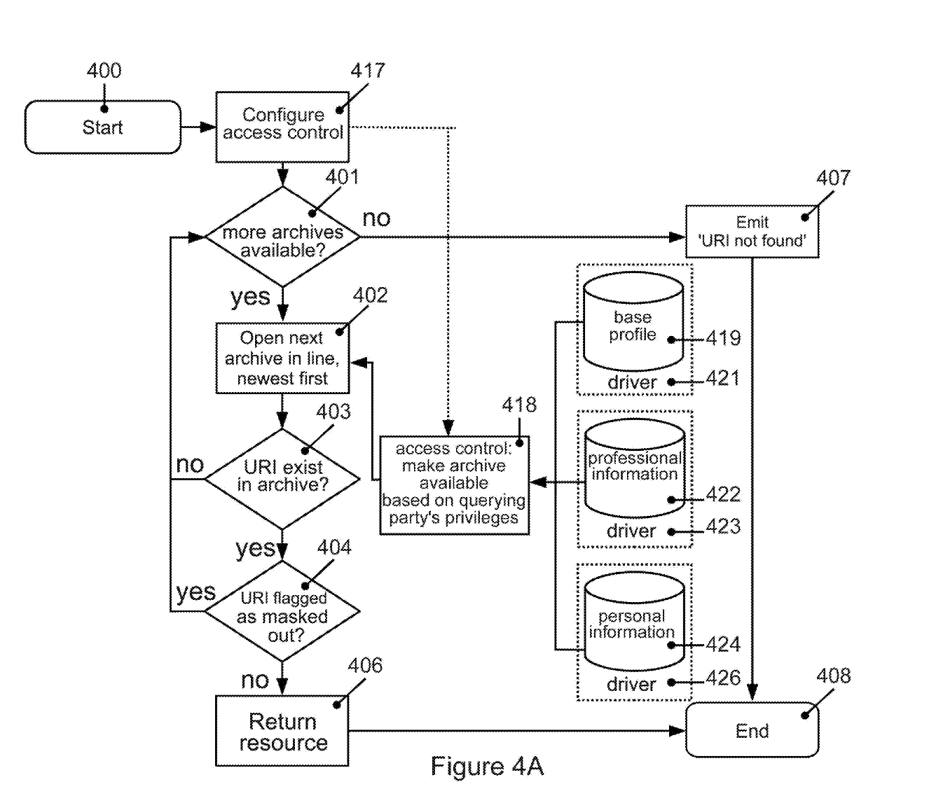

FIG. 4 illustrates a preferred and simple implementation of the system to retrieve a resource at a specific URI. A number of separate archives 409, 412, 414 are exposed to the system via their (storage platform-dependent) drivers 411, 413, 416. For example, archive 1 denoted by 409 could be located on a server on the Internet, archive 2 denoted by 412 could be located locally on a file system on CD-ROM, while archive 3 denoted by 414 could be located in RAM. The individual drivers 411, 413, 416 offer a unified interface for accessing the contents of the archives on their respective native storage-platforms.

Due to the aforementioned modesty of a driver implementation's requirements, an archive reader (‘driver’) can be accomplished in virtually any computer language (whether compiled or interpreted) on virtually any platform that can expose a chunk of contiguous memory for random access reading in some sort of data store environment. For example, a website's content can actually be transferred (in part, or as a whole) into the web browser's HTML 5 local storage (‘Web Storage’) area. Having the content available locally like this, obviously circumvents the need for making any requests to a webserver, greatly speeding up access times and reducing any server load beyond, perhaps, transferring the content once and periodically checking for updates to the content (if a central distribution mechanism for the content is desired). The content itself can be extracted on-demand by JavaScript™ running locally on the client in, for example, a web browser.

It may be noted that, as long as drivers are available for the storage platforms where a content archive resides and one of these drivers is able to write, content archives can be updated at will. For example, one content archive may physically reside in an Android™ OS APK bundle (which is read only), while another content archive may reside on an external SD card (allowing read and write), while yet another content archive may reside on a remote server that the Android™ device is connected to (allowing read only). As long as the three archives are mounted and drivers exist for the different means of accessing the content archives (in this case an APK resource bundle driver, a SD card driver and a network driver), the Android™ application will regard the three mounted archives as one monolithic content source. If just one of the three drivers provides write access to one of the three mounted archives, the content as a whole can be updated and added to.

As an example, in the context of an Android™ smartphone app, archive 1 in FIG. 2 could, for example, reside in the read-only app resource bundle that comes with a fresh installation of an Android™ app. Archive 2 could be a subsequent download to the SD card, which, combined with archive 1, now adds more resources for the final app to use (for example, two more images), as well as an updated resource F (updating an old image with a new image). Similarly, deletion of archive 2 from the SD card would make the app revert back to its ‘virgin’ state of just having four images, one of which displays an older version of an image. Those skilled in the art will recognize that this effectively constitutes an update ‘roll-back’ ability.

Embodiments of the invention allow for great flexibility and future proofing with regard to how content is distributed and where content is stored. For example, some or all content may be cached locally, some or all content may hosted on a remote web server, some or all content may be distributed in a peer-to-peer or viral manner (for example by ‘bump’-ing smart phones or near field communication), some or all content may reside on a private server, some or all content may reside on a public server, some or all may be distributed via physical media, etc.

It may be noted that the ease with which content is carved up across multiple mountable archives and distributed across different distribution methods, lends itself well to downloadable content and monetization thereof through a digital rights management scheme. For example, an archive may be mounted for users who have paid for an archive's content, while the archive will fail to mount for a user who has not paid for an archive's content. Any freely accessible archives will mount for both paying and nonpaying users.

It may also be noted that, combined with a form of analytics that reports on the usage of content, the ease with which content is carved up across multiple mountable archives and distributed across different distribution methods lends itself well to ‘A-B’ testing of different content packages. Different versions of content may be distributed at random to measure the efficacy of the packaged content by means of an analytics reporting solution (such as Google™ Analytics) on the different versions.

Similarly, through implementation of an embodiment one could envision using the present invention to host a social media profile where different users in the social graph will see different resources (different archives are mounted in order to display different resources) depending on who is viewing the profile and what their relationship is with the profile's owner. FIG. 4a illustrates how adding an access control mechanism 418 to the flowchart of FIG. 4 allows for exposing different archives (and thus different aspects of a social media profile). For example, a business relation could see the basic details of name, age and gender, plus occupational details such as place of work and previous job titles, while a more personal relation would also see the basic details, not see the occupational details, but instead see the picture gallery from last night's party. A user with no or just basic privileges would just see the base profile, while a very close relation (for example a family member) would be able to see the aggregate of basic, professional and personal information.

It shall be noted that, in addition to the DRM mechanism discussed earlier (e.g. DRM by means of physical distribution of archives that contain content that was, for example, paid for), the latter access control could effectively be used as an alternative DRM mechanism; as such, all archives could be distributed to a device but a rendering system could restrict access to them, based on, for example, whether an archive's content has been paid for (a central DRM server could be queried for this information).

Moreover, in a preferred embodiment, the present system would make it possible to create personalized renditions of the user's profile for the relation viewing the profile. For example, the person viewing the profile could create their own local archive to mount on top of another user's profile, such that a mom could, for example, keep baby photos of her son attached to her son's profile locally, without anyone else seeing them (since the ‘special’ archive with the baby photos exists only locally on her viewing device).

A similar local customization by mounting a local archive in addition to a ‘common’ set of archives could, for example, come in the form of annotations that a user would make, where the rest of the archives contain the contents of a book.

Note that both in the previous book example and in the local social media profile example, nothing prevents the individual user from sharing that data too, through aforementioned distribution mechanisms (for example, client-server, peer to peer, near field communication, etc.).

Given the great flexibility with regard to how content is distributed and where content is stored, a medium, platform or service's resource requirements can also be reflected in what is stored locally and what is left stored remotely. For example, a smartphone app may elect to leave large media files such as videos and audio stored remotely, while also mounting (and keeping up to date) a local copy with just the smaller files. Platforms, media or services that do not require audio or video at all may dispense with considering these files for local storage altogether. A player of the content for the vision impaired may, for example, ignore any sort of visual content and instead only render content that can be translated into an audio signal such as menu items, text paragraphs and audio. Some platforms, media or services may give the user an option of what to store locally and what to leave remotely in the form of downloadable content.

The system's content storage solution described thus far addresses flexible future-proof cross-platform content storage, separate from form and function. The following describes how platform-specific form and function make use of the stored platform-independent content.

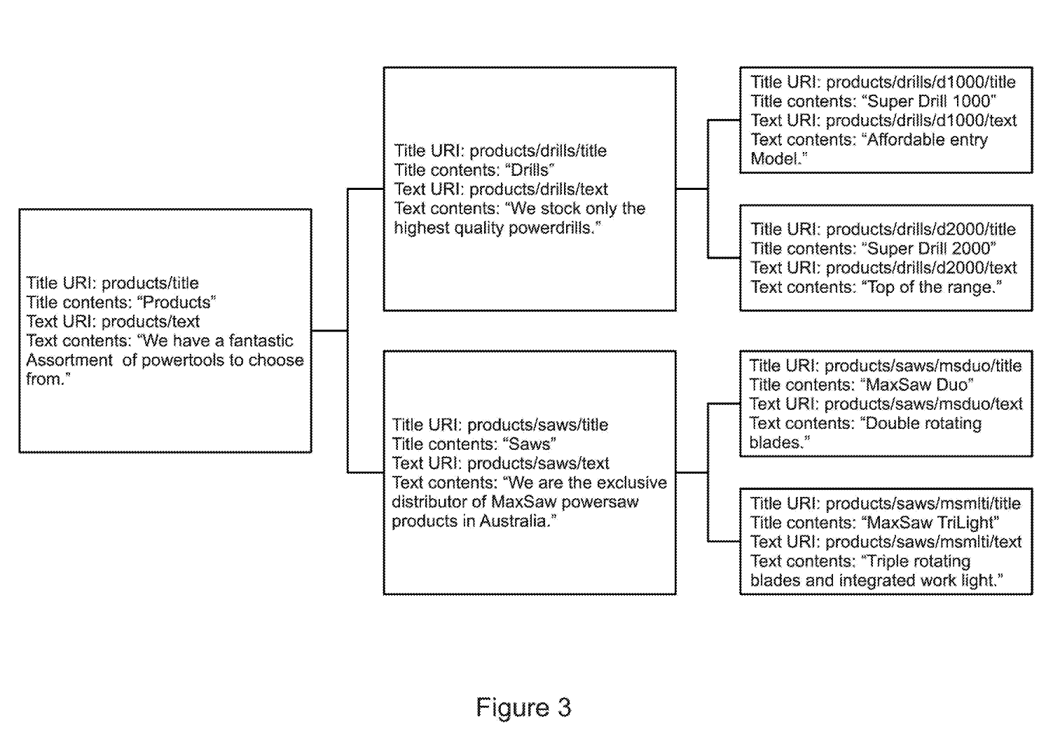

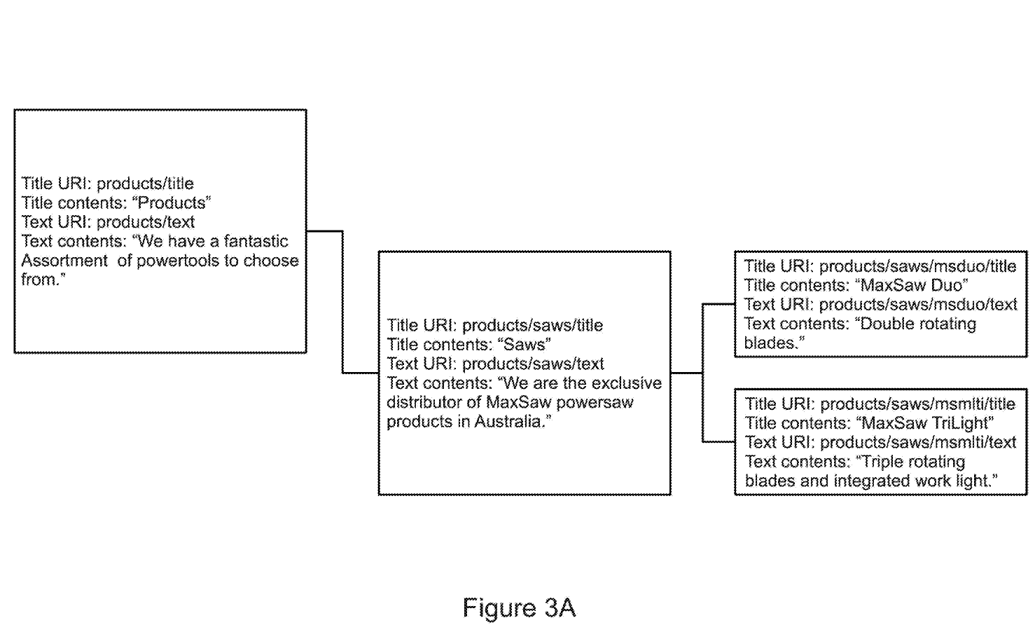

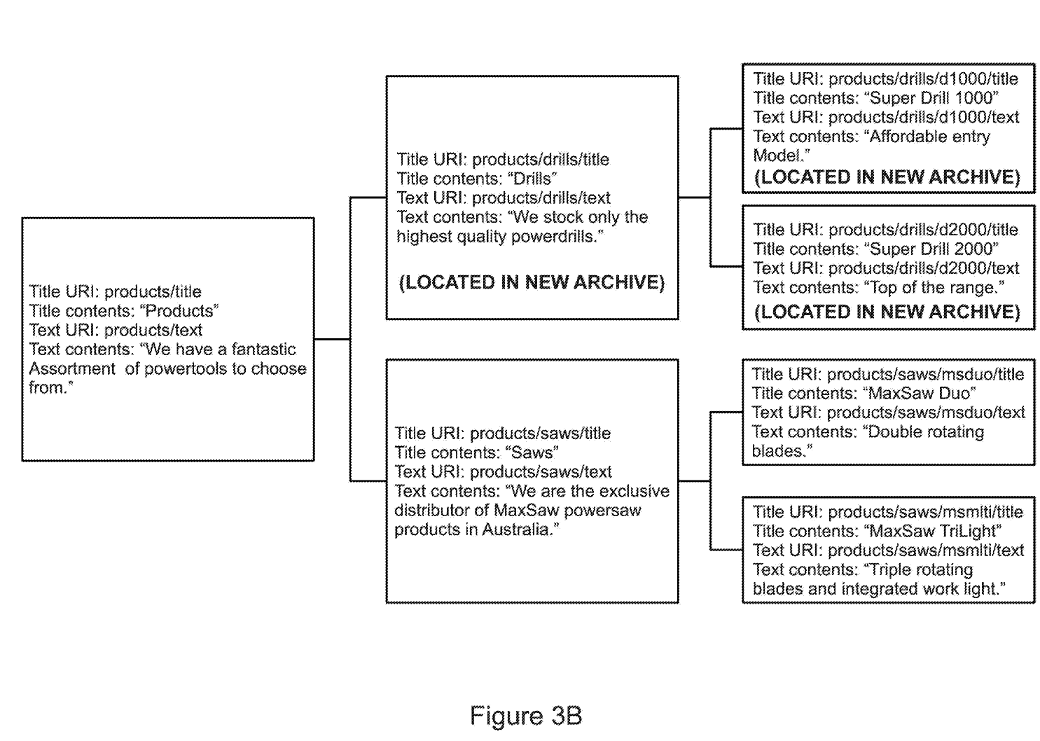

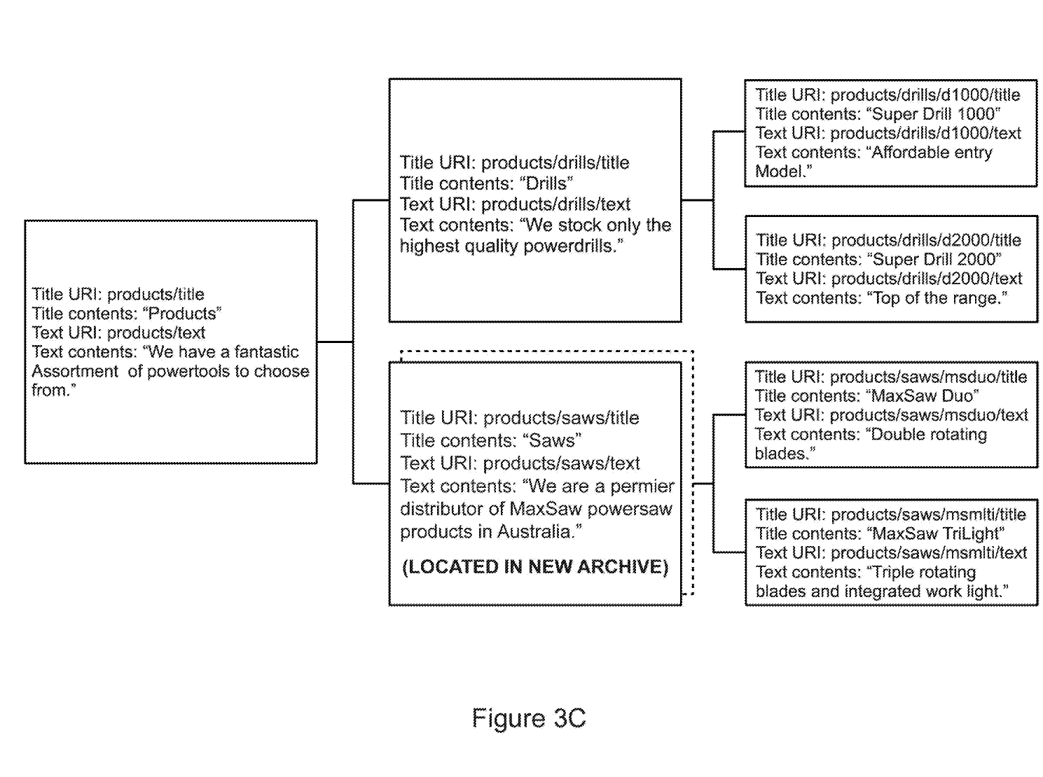

Content in the union mount follows a hierarchy by means of a navigation tree, analogous to a site map or a file system directory structure. FIG. 3 illustrates an example of such a hierarchy (tree). In a preferred embodiment of the present invention, the child-parent relationships for each URI are implicitly encoded into the resource URIs themselves by the use of designated delimiters (for example slashes, as is common on UNIX-based systems), avoiding the need for explicitly encoding and managing of directories/containers (as found in prior art that concerns system-wide file systems), thus allowing a simple file format for the archive as described in relation to FIG. 8. Alternatively, some other mechanism could be used to store the parent-child relationships for the nodes (and their associated resources) of the hierarchy/tree, as will be apparent to those skilled in the art.

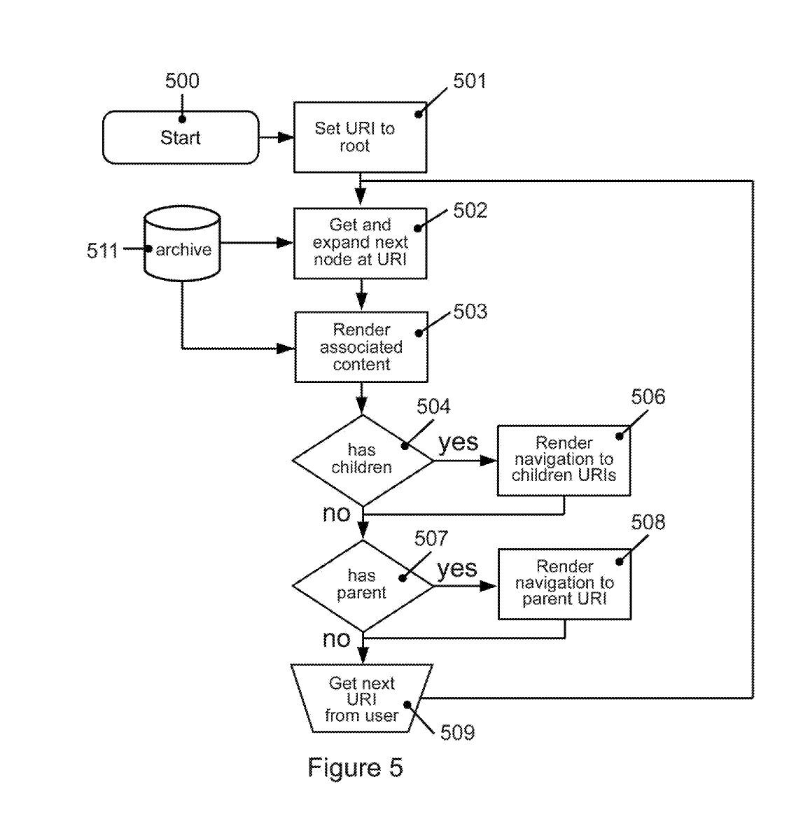

Navigation of the content is accomplished as follows. Upon opening the content, the ‘viewer’ (it shall be noted that ‘viewer’ in this context means any sort of renderer, even if the renderer is completely non-visual in nature) expands the node at the root, for example ‘Products’ in FIG. 3, and displays the associated content “We have a fantastic assortment of power tools to choose from”. The ‘root’ node in terms of a website is the home page, in terms of a smartphone app is the home screen, in terms of an audio menu is the main menu, etc. The expanded node shall also render either a means of navigating to its children (‘Drills’ and ‘Saws’), and/or perform some other action with its children's content, for example, display the children's content in addition to the root content and render a means of navigating to the grandchildren. The expanded node makes means available at all times to navigate down the hierarchy or up the hierarchy, except if no nodes exist down or up the hierarchy, or navigating up or down the hierarchy will not enable the user to experience materially more content (for example, an item that leads to video content for an audio-only ‘viewer’, or on a viewer that has already pulled in content from its children and those children are leaf nodes beyond which no content exists). The flowchart in FIG. 5 shows the logic of a very simple viewer. Note that, referring back to the content storage system, any one of the nodes' associated resources could reside in different archives. For example, the ‘Drills’ branch may have been added by a second mounted archive indicated in FIG. 3b, after the ‘Saws’ branch already existed in a first mounted archive as shown in FIG. 3a. At this point the system and its viewers regard the content as a whole as depicted in FIG. 3. To complete the picture, FIG. 3c, finally, illustrates a third archive that overrides a text contents resource to reflect an update in distributor relations (note that it is of course sufficient to override just the text contents resource, leaving all other resources as they were), and so on.

Note also that from the flowchart in FIG. 5, for the sake of simplicity, the navigation does not evaluate any other parts of the hierarchy and just concerns itself with the current node, a link to its parent node (if any) and a link to its child node (if any), constituting the minimum that is required to be able to navigate the hierarchy. It implements the simplest possible viewer, rendering the content at the current node URI and providing the user a means for navigating to the parent or children nodes of that URI, after which the process repeats itself upon the user's decision. The decision being which node to navigate to next. Accordingly, the full hierarchy can be explored this way, rendering the content at each visited node. Viewers for platforms that have the real-estate to render more of the hierarchy may do so, for example rendering child nodes and/or possibly rendering nodes or branches of the hierarchy that the current node isn't even a member of, for example by always having the immediate children of the root node available on a screen as well, so that the user can quickly start navigating down a completely different branch.

However, it should be noted, that different viewers can be configured for different nodes: the home page on a website may display its children (and/or grandchildren) differently than the rest of the website once the user starts drilling down into the hierarchy. Viewers are free to implement any form or functionality that a specific platform supports, using any technology available. For example, some viewers may implement search functionality to quickly search the descendants of the currently displayed node (for example searching in ‘Products’ for a specific model, part number or keyword). Some viewers may elect to use HTML and CSS to give form to the content, while others may want to use OpenGL or DirectX to give form to the content.

To this end, nodes of the hierarchy can be provided with rendering ‘hints’ on how to most effectively display, use or render the content. For example, different viewers may be appropriate for browsing different types of content, or it may be the case, for example, that some content is too rich for a particular platform, for example, a full catalog of products in the case of an audio-only platform. In the latter case, viewer configuration hints can help invoke different ‘viewers’ on such a platform and help them decide to not ‘show’ the section in question at all. Another example is a website which, under its root (home) page has a child with an image slide show. A viewer configuration hint may indicate that it is preferred that the slideshow should be prominently placed on the homepage as may be custom on websites. However, the hint may be completely ignored by a smartphone app, which may still ‘list’ it as a separate selectable child item in a menu to reserve screen real-estate for other content or purposes.

Whereas rendering a means of navigating the hierarchy is mandatory for perusing content, ‘hint’ interpretation is optional and, in principal, only a simple single viewer implementation per platform, such as that described in connection with FIG. 5, may suffice to navigate the full content hierarchy from its root node, via its intermediary nodes to its leaf nodes, and back again. Any embellishment beyond presenting some sort of navigation interface is strictly in the realm of the platform-specific content viewer, not the content itself; where ‘form’ remains separated from content. The content itself shall not definitively prescribe which content resources are rendered per node, nor in what manner the content shall be presented. Hints are to be regarded as serving suggestions and not necessarily as mandatory. As hints and resources may always be safely ignored if needed, specific hints or resources may pertain to specific platforms without impacting others. The latter may help support or trigger specific functionality.

In a preferred embodiment of the invention, hints are simply encoded as just another resource into the hierarchical structure, for example as a comma separated list of human readable words, or as some other collection of tokens that may, or may not be human readable.

The mere presence of a particular piece of content in a node's associated content list may be enough for a viewer to display it and/or offer platform-specific functionality around a piece of content; no hints shall be necessary a priori. For example, the presence of a PDF file at a node's level can be enough to show a ‘download PDF’ button on a website showing the node's associated content, or can be enough to show a ‘view PDF’ option on a smartphone equipped with a PDF reader.

The same content and associated navigation may even behave differently on the same medium, platform or service, depending on contextual characteristics of the medium, platform or service. For example, when an Internet connection is not available, any content that requires such a connection may be removed from the navigation, as it makes no sense to offer it as an option to the user if the content cannot render or function without an Internet connection. Similarly, if the smartphone of the previous example does not have a PDF reader, the option to ‘view PDF’ may be withheld until the user installs a PDF reader.

It is important to note that storing content in the hierarchical navigation model has the added benefit of granularization of the aggregate content; the aggregate content gets neatly broken down into piecemeal content that (necessarily) facilitates a decision for the user with regard to what to drill down into next. The benefits of this are threefold.

Firstly, it helps the content creator stay ‘on message’ and create relevant content for each node, since the content for the node needs to reflect the nature of the connection between child and/or parent nodes in order to make sense to the user navigating the hierarchy.

Secondly, it greatly aids the machine readability of the content and semantic processing of the content. This has, for example, important implications in terms of Search Engine Optimization (SEO) and other services or algorithms that deal with the semantics of content. Because the message is so condensed, on-topic and specific for each node in the hierarchy, it is much easier to algorithmically distill meaning from the content and ascertain what the content is about and how it relates to other content up and down the hierarchy (e.g. the content's “context”). For example, a search engine algorithm (such as Google, Yahoo or Bing) visiting a URL that reflects the content of a single node in the hierarchy will have a much easier time distilling what the content is about, and hence be able to definitively rank the content with great accuracy for the particular themes and keywords at the URL. This is in contrast to content at a URL that carries multiple topics, themes and keywords, which will dilute the ‘meaning’ that can be attached to the URL. Such URLs will rank lower for any of the keywords, themes and topics distilled since they do not accurate reflect the content at the URL just by themselves. Even more so, by looking at the ‘context’ of the content (being the parent and child node content), machine readability and meaning can deal with ambivalence even better. For example, if the node's' content is about a ‘date’, and the parent's content node is about ‘January’, the analyzing algorithm can assume that the node's content is about a time of the year, rather than a romantic encounter or the fruit. Machine readability and the ease by which meaning can be derived from the content, of course also benefits the search-ability of the content by the application serving and/or rendering the content, for example by generating keywords from the content which can then be searched.

Thirdly, by modifying the archive's file format (and/or the sequence in by which the resources are added into the archive) in such a way that all high level resources are stored first, followed by resources that reside at increasingly deeper levels of the hierarchy (e.g. sorting the order by which the resources are sequentially stored in the archive according to the order by which a breadth-first tree search would expand the nodes of the hierarchy that is implied by the resource URIs), it is possible for a viewer to already present a meaningful amount of content and navigation to the user, presenting the top level of the hierarchy, even when an archive has only partially materialized (for example when it is still being transferred over a network connection). Since everything may already be available to completely render the top level of the hierarchy (allowing the user to start making decisions on what to drill down into next), there is no reason for the viewer to wait until the full archive has become available.

Again consider FIG. 3, showing a simple example of a hierarchy. In the simple example the relationship between the nodes is clear; for example, the drill models are sub-items of ‘drills’, and ‘drills’ in turn is a subcategory of ‘products’. The associated content is therefore also related in a similar manner; a node's associated text will be descriptive of the child nodes, as they are intended to inform the user's navigational choices.

For example, when using the present system for publishing a book, the relationship between nodes could be characterized by a ‘book’, ‘chapter’, ‘paragraph’, ‘text’ relationship, as well as a ‘book’, ‘chapter’, ‘paragraph’, ‘image’ relationship. A viewer that is meant to render the book then can show a hierarchy to let the user select a chapter, and the viewer can accurately determine which image goes with which paragraph. The latter gives different viewers on different devices free reign to place the image ‘near’ the text of the paragraph (or even just show it as a clickable link), depending on the screen real estate available and/or the capabilities of the platform. For example, the image could be completely disregarded if the ‘viewer’ is rendering to an audio-only channel; effectively turning the content in an audio book.

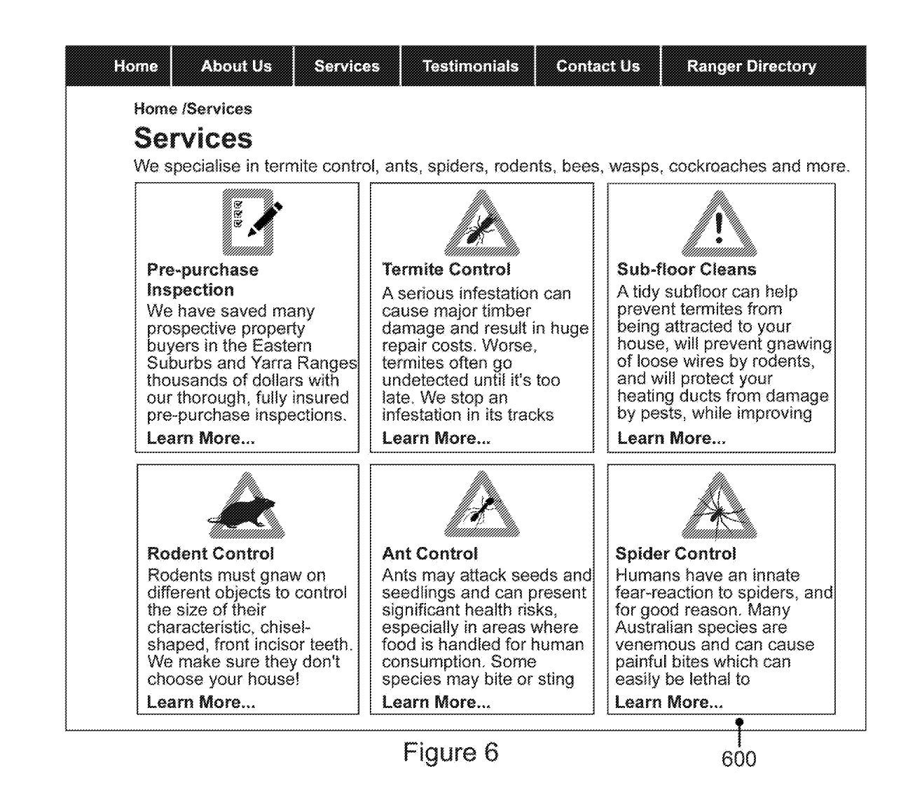

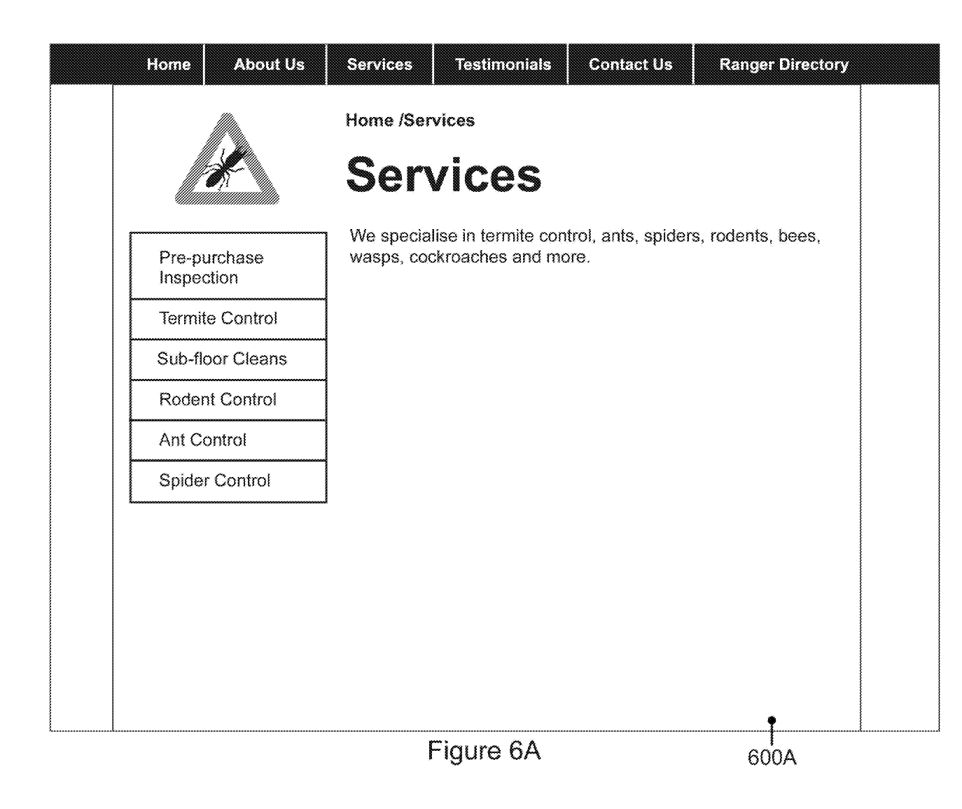

As alluded to hereinbefore, viewers may also display content that is not necessarily associated with the current depth level, or even its branch, of the node that is being viewed. For example, a website may display the root's children, being the main content sections, at the top of the web page for quick navigation between ‘main’ sections, as is a common design pattern/practice in websites. An illustration of this is given in FIG. 6. Upon hovering over one of the sections with a mouse pointer, the viewer may even display those section's children, i.e. the root's grandchildren and so on, effectively showing content two levels down or more from the root note for a completely different branch of the hierarchy than the user currently is traversing. As opposed to prior art, there is no maximum or restriction to how much content and navigation options from the full hierarchy may be displayed at once and which options, besides the current node's parent and child node, are visible to navigate to.

A less extreme example is in the case of the previous ‘book’ example, where a viewer would, for example, likely display multiple ‘paragraph’ nodes underneath each other to fill up a page.

The sole requirement is that the user can visit and experience all relevant nodes. In this context, irrelevant nodes can be considered as being nodes that have no renderable resources associated with them, such as nodes that just have a video associated with them while the ‘viewer’ is an audio-only channel.

The examples in FIG. 6 and FIG. 6A show different viewers displaying the same node. The viewer in FIG. 6 shows a much richer view and has chosen to, in addition to the current node's content being ‘We specialize in termite control, ants, spiders, rodents, bees, wasps, cockroaches and more.’, to pull in the 1st paragraph of the content of all the current node's children as well. The viewer in FIG. 6A on the other hand has chosen to keep it simple and just display the current node's content and a list of clickable links to each of the children of the current node. Both viewers additionally include the top-most node ‘Home’ and its children ‘About Us’, ‘Services’, ‘Testimonials’, ‘Contact Us’ and ‘Ranger Directory’, in the form of a navigation bar at the top. Additionally, both viewers offer the user a way to move up the hierarchy by displaying a clickable link to the parent as noted be ‘Home’ next to ‘/Services’. The viewer in 6A pulls in an additional graphic for embellishment, namely, a triangle sign with a cut-out of a termite. Note, however, that in the end both viewers offer the same general aspect of the content, namely, a ‘Services’ page that may let the user find out more about the services on offer. The viewers do so in different ways, with different degrees of content richness and different degrees of functionality. In the instance of this example the links that can be clicked differ, such as illustrated in FIG. 6, where a ‘learn more’ link under an excerpt of each child's content is made available, whereas a more compact selection menu is provided in FIG. 6A. However they source their content from the same place. However they source their content from the same place. Both are equally valid renditions of the content, however where the viewer in FIG. 6 can easily fill more than a full screen on a desktop computer, the sparser content richness in FIG. 6A is much more suited to a smaller screen, such as that of a smartphone.

Now that exemplary embodiments of the present invention's inner workings have been explained, it is possible to demonstrate the present invention in the form of preferred embodiments on different platforms. As previously mentioned, it is notable for all examples that a central repository that pushes out new archives to all these embodiments of a content distribution, for example over an Internet connection, would allow all these embodiments to serve the same content. Again, it shall also be noted that the viewer code for each of the illustrated platforms shall, at minimum, function along the lines of the flowchart in FIG. 5, while the aggregate content shall, at minimum, be exposed along the lines of the flowchart depicted in FIG. 4. For the sake of example, we can assume simple content (ie a node title, some node text) is handled as depicted in FIG. 3.

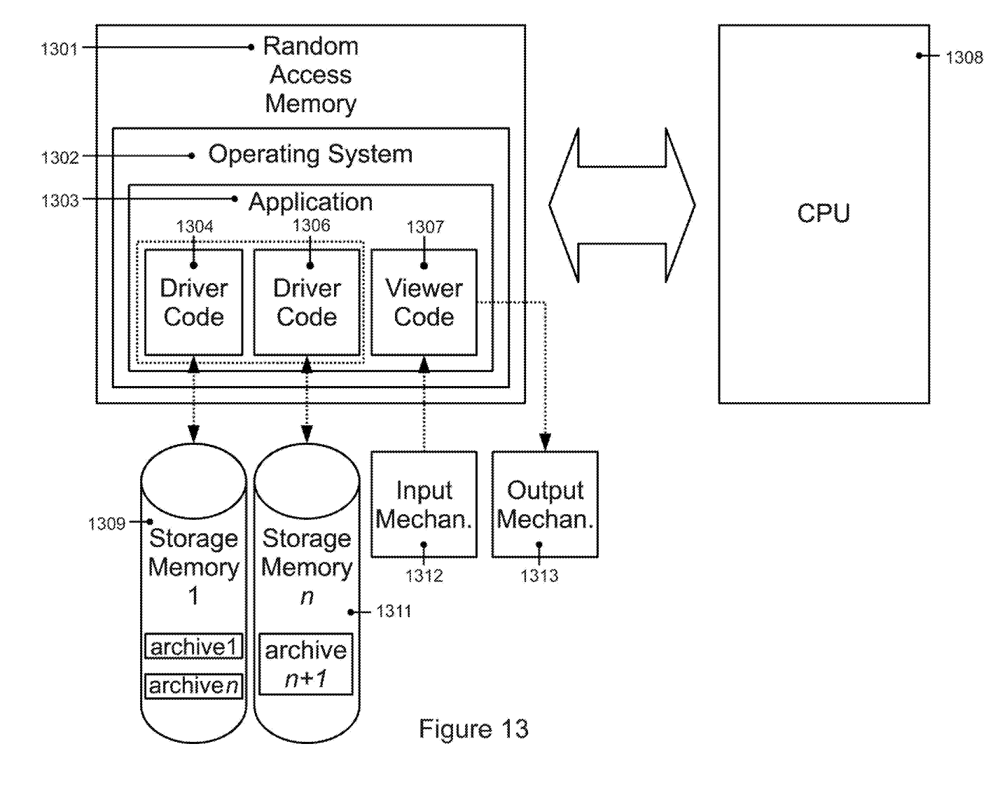

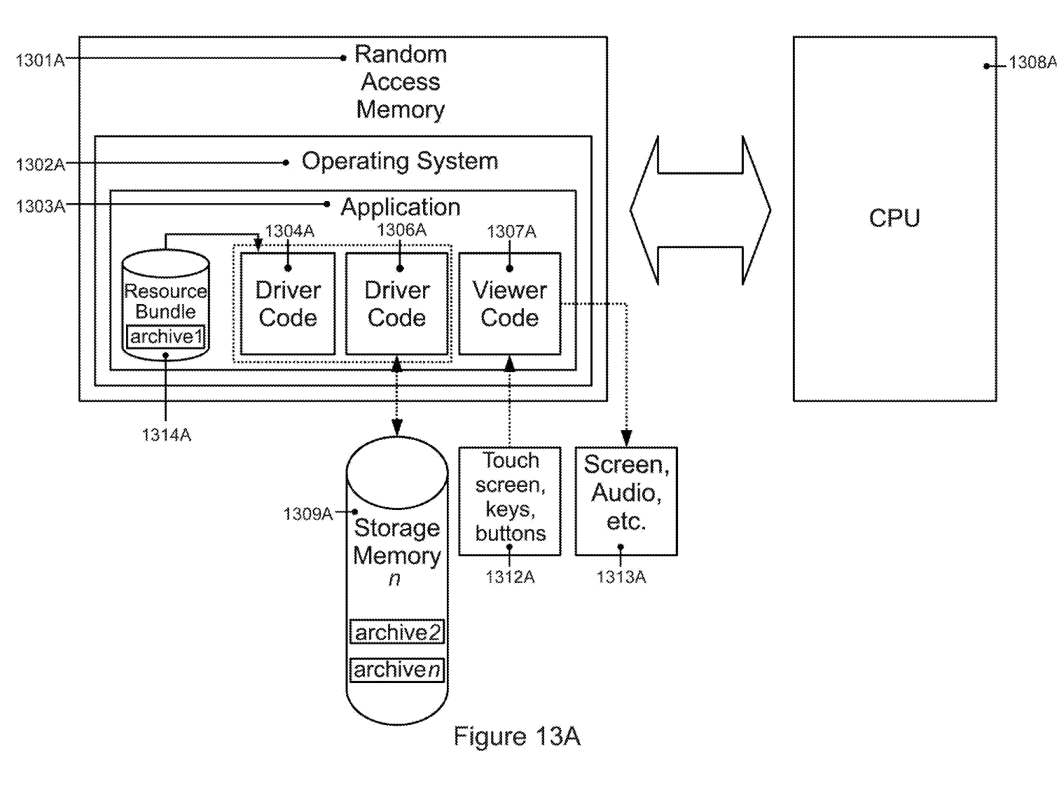

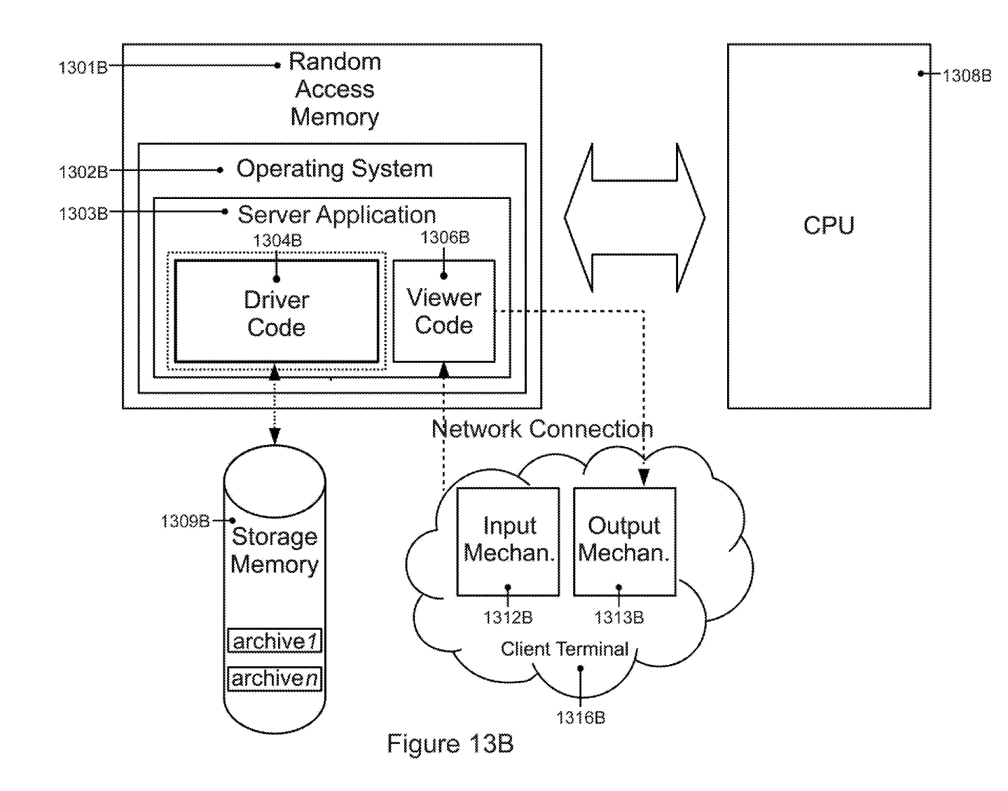

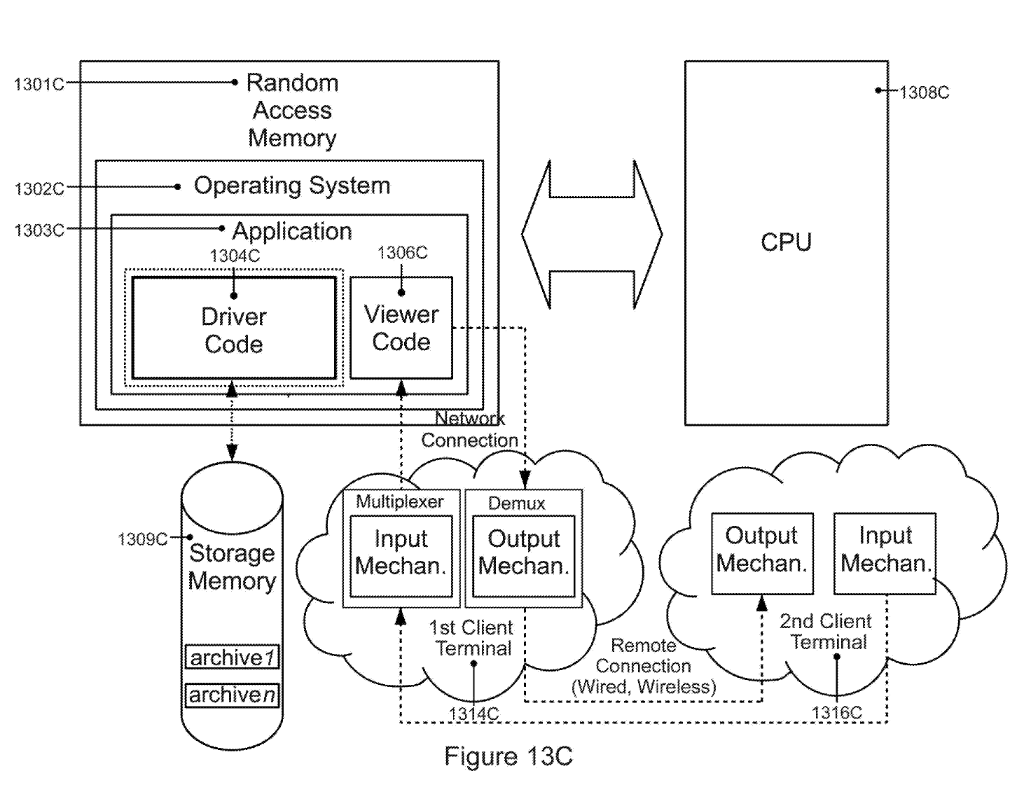

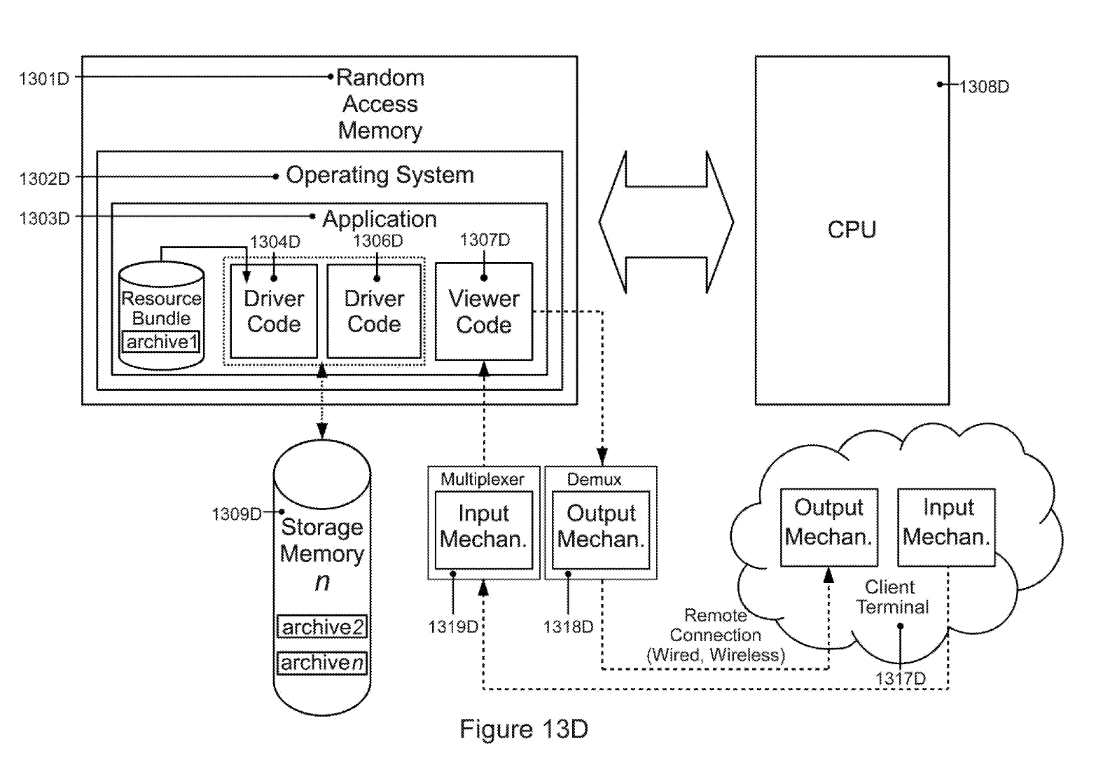

In FIG. 9, a preferred embodiment of the invention is illustrated on the Google Android™ platform on associated hardware configured according to FIG. 13a. FIG. 9a shows three examples of three distinctly different distribution mechanisms; distribution by means of a download using a client-server Internet/Network connection, distribution by means of a physical medium using an SD card, and distribution by a peer-to-peer ad-hoc network connection by means of Near Field Communication. In this instance, a ‘base’ version of the content is distributed with the application, namely, ‘archive 1’ denoted at 901, as part of a read-only resource bundle corresponding to 1314A in FIG. 13a. A driver 903 for reading an archive from the resource bundle 1314A, incorporated in the executable code 1304A of the application, exposes content to the code of the viewer(s) 1307A. The viewer code 1307A makes use of the native capabilities of the Google Android™ platform to fulfill form and function. The Android™ executable code contains code for a second driver 904 with driver code 1306A that is able to mount a second archive 902 (or third, etc.) from storage memory. Together with the aforementioned resource bundle driver 903, this driver exposes the aggregate result of the overlaid archives 911 to the viewers, eg 906. In FIG. 9, no archives exist in storage memory yet. This situation is typical of a ‘fresh’ installation of the application, where ‘base’ content is delivered along with code by means of, for example, a vetted app store download.

FIG. 9a illustrates the same Android™ application. However, in this instance, a second archive 902A has been put into storage memory, which allows the content of the first archive to be augmented, modified, or deleted (masked out) by means of the union mount mechanism. The second archive 902A could have been put there through a user (or application) initiated Internet download, insertion of a physical medium, for example an SD card, through file synchronisation by means of Near Field Communication technology, ie ‘bumping’ phones, etc. Since the storage memory may be write-enabled, the driver providing access to archive 2 (902A) could expose writing capabilities to the Android™ application code as well, enabling universal content authoring also, which then optionally could be distributed to other platforms for perusal.

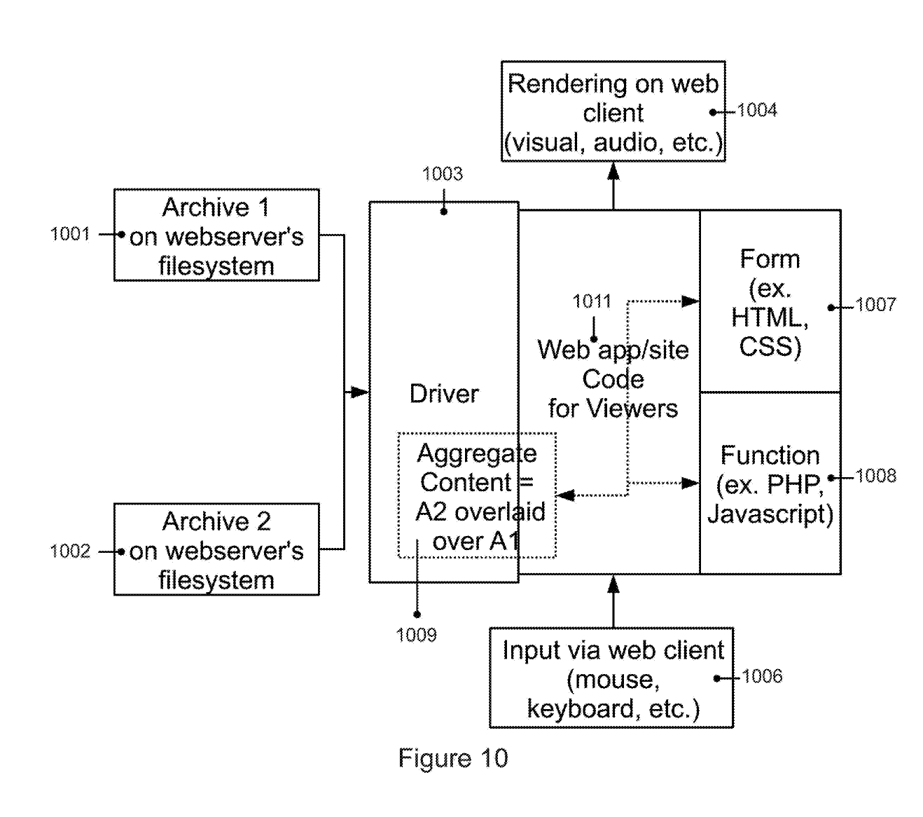

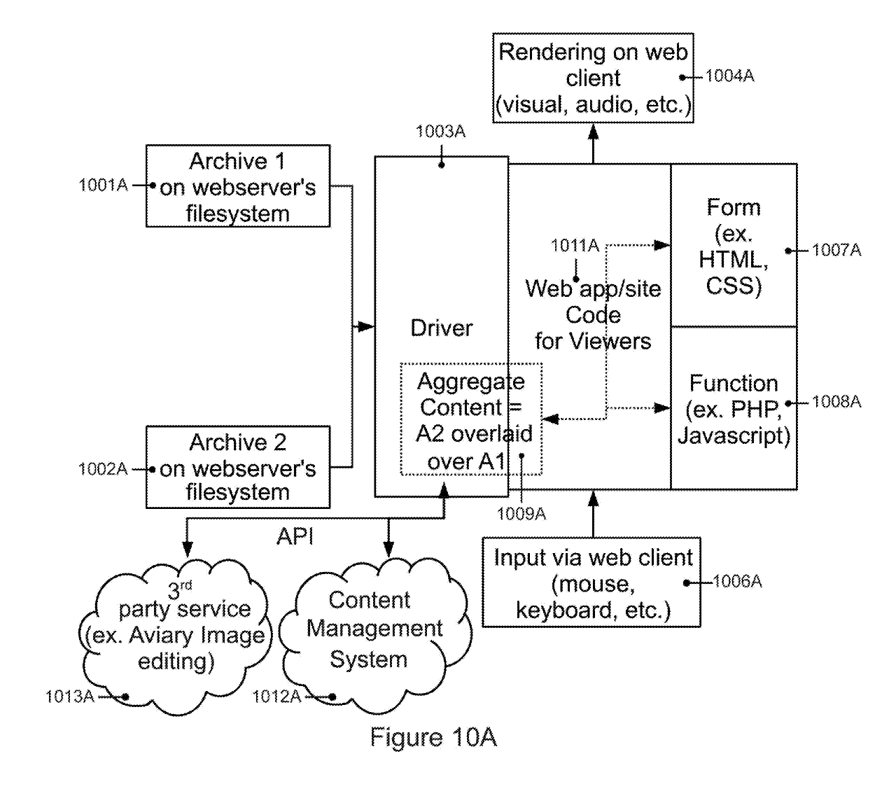

FIG. 10 illustrates a preferred embodiment of the invention as a website on associated hardware configured according to FIG. 13b, also using the same two archives 1001, 1002 from the previous example. This time a single driver 1003, which is part of the webserver's executable code, is sufficient since in this example both archives reside on the same type of storage memory. In this case, the archives reside on the webserver's native filesystem. It would be recognized by the person skilled in the art that, like all websites, the ‘Web app/site Code for Viewers’ comprises a mixture of client side and server side code, resources and data caches, which are not illustrated. As is usual for websites, input 1006, for example the next URI to render, is taken from the remote client, after which output is also rendered on the remote client 1004. As mentioned hereinbefore, a solution (not depicted) is envisaged where the archives 1001, 1002 are distributed to the web client and the drivers 1003 reside on the client side, written, for example, in JavaScript.

FIG. 10a illustrates a preferred embodiment of the invention as a website or service, similarly suitable for utilization with hardware as depicted in FIG. 13b, where the website or service incorporates content authoring capabilities as well. A Content Management System (CMS) 1012A uses the driver 1003A (via an API) to read and write content into archive 2 (1002A). Also depicted in FIG. 10a is a third party service 1013A which, could also use and modify the content of archive 2 (1002A) if given access to the driver 1003A (via an API).

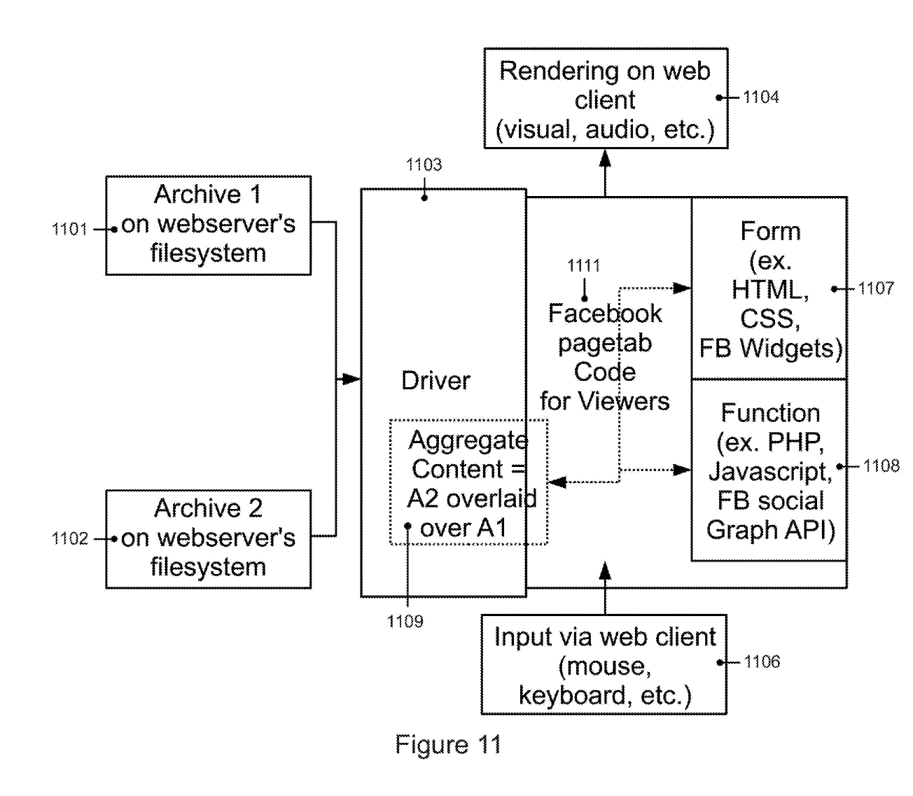

FIG. 11 illustrates a preferred embodiment of the invention as a Facebook page tab. Since a Facebook pagetab is essentially a website contained in an IFrame, which is essentially an HTML document embedded inside another HTML document on a website, it does not differ much from the website implementation of FIG. 10 and would therefore be implemented using the same hardware as depicted in FIG. 13b. The notable exception to the implementation illustrated in FIG. 10 is that the Facebook environment exposes additional functionality and resources that are unique to the Facebook environment. The fixed and smaller size of the IFrame may also make it desirable to present content in a more compact way.

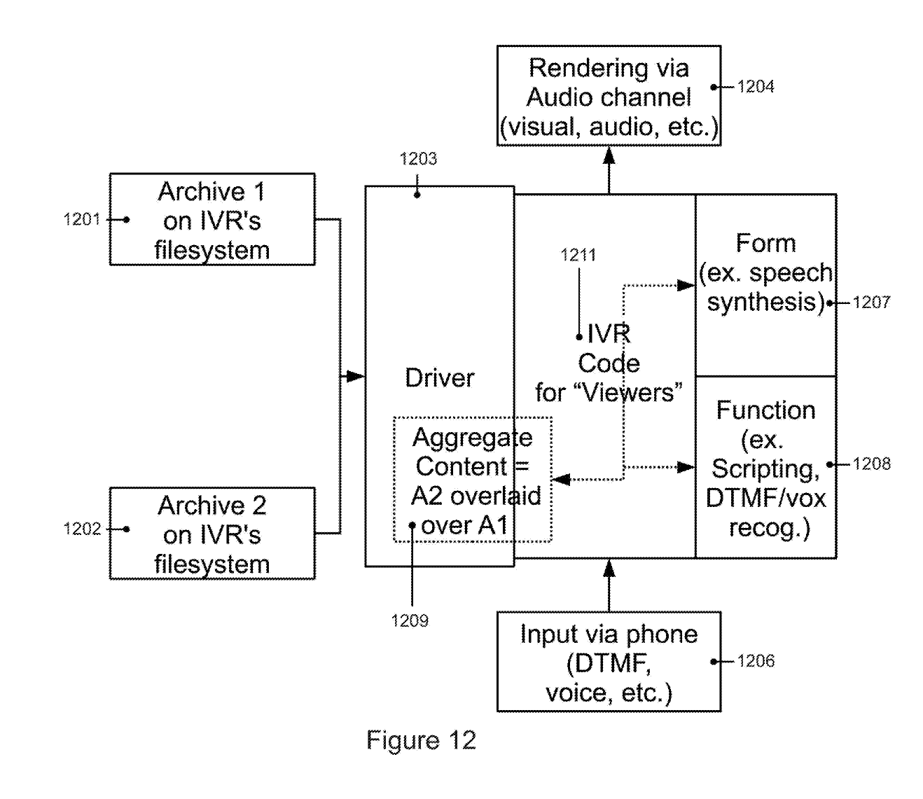

FIG. 12 illustrates a preferred embodiment of the invention implemented as an Interactive Voice Response (IVR) system. This system may be implemented over a hardware infrastructure similar to the generic hardware illustrated in FIG. 13, where the input mechanics on the user side are a Dual Tone Multi Frequency (DTMF) tone-generating keypad and the output mechanics may comprise a voice generated by speech synthesizer. Note that while this system is obviously audio-only, the same content archives can still be effectively presented and navigated as long as the content has a hierarchical relationship and each node has at least some sort of renderable resource. In the case of the content depicted in FIG. 3, there are titles and text contents, as shown, which can be readily converted by a text-to-speech engine and injected into the audio channel. If the current node's URI were ‘/products/drills/’, a user could, for example hear; “Drills. We stock only the highest quality powerdrills”. Conveying a navigation interface could be as simple as injecting instructions into the audio channel along the lines of “Press 1 for Super Drill 1000”, “Press 2 for Super Drill 2000”, “Press # to return to Products”.

Where a ‘base’ version of the content is distributed along with an application, for example in the case of the Android™ APK, where the resource bundle incorporates this ‘base’ content, this base version of the content (‘archive 1’) must be the same everywhere across all platforms, else any subsequent ‘updates’ in the form of additional archives may not result in the same aggregate content being available on all platforms.

Another embodiment is shown in FIG. 13c, which depicts hardware configured for an application of the invention where an augmenting 2nd Client Terminal 1316C, for example a ‘wearable’ class of device, such as a smart watch or Google Glass, uses a connection to an intermediary 1st Client Terminal 1314C, for example, a smartphone running a mobile web browser, showing the output of the viewer code to relay optional input to the viewer code potentially allowing controlling the viewer from both the 1st and 2nd terminal. The configuration further allows both the 1st and 2nd terminal to receive tailored output from the viewer code in response to the input from the 1st client and/or the 2nd client.

The configuration of FIG. 13c allows for, by way of example, an application where a mobile website may be navigated from both, for example, a smartphone and a smartwatch at the same time and where both smart phone and smartwatch receive a new relevant viewer comprising content, form and function suitable for the platform to render in response to input from the smartphone and/or the smartwatch. In other words, both smartphone and smartwatch may be given the capability to request a new viewer by altering the currently viewed URI (per the ‘Get next URI from user step’ of the flowchart of FIG. 5). It shall be noted that most prior art systems will have difficulty coming up with viewers that present, at least, aspects of the content that belongs to a URI in such a way that rendering capabilities of, for example, a smartphone and a smartwatch, are fully utilised in response to selecting a new URI whose associated resources, form and functionality of both the smartphone and the smartwatch will render at the same time; selecting the same URI simultaneously will, using the present invention, provide a meaningful experience on both a smart watch (with very limited real-estate and rendering capabilities) and a smart phone (with comparatively much more real-estate and rendering capabilities). The reason for that is that the different viewers in the present invention have access to the very granular hierarchically related content, which makes it easy to show many or few ‘granules’ of information at the same time (for example, as previously illustrated through FIGS. 6 and 6A).

The flexibility of embodiments of the invention are illustrate in FIG. 13d, which shows hardware configured for an application of the invention where the viewer code is run locally, for example, as a native smartphone app, as opposed to remotely by a webserver as seen in the previous example and FIG. 13c) and where a client terminal, for example, a ‘wearable’ class of device, such as a smart watch or Google Glass, similar to the previous example uses a connection to the configured hardware running the viewer code.

Similar to the previous example, the client terminal 1317D is able to optionally control the viewer code, in addition to the hardware device running the viewer code. For example, both the client terminal 1317D and the device running the viewer code can be used to navigate the content and interact with the content. Both client terminal and hardware device render new content, form and function in response to input from the client terminal and/or input from the hardware device.

The hierarchical nature of the content relationships, not only allows for a universal and intuitive way of navigating said content; it also allows for a universal and intuitive way of constructing it; when building a content source, a content creation and management system can be envisioned that gives the user, who is creating the content, a tree overview. Branches could, for example, be freely dragged around and re-attached at any level, while a separate interface allows for the detailed editing and specification of each node and associated content. This is advantageous over content management and creation systems that enforce no structure and may also, for example, allow recursive linking and ‘infinite loops’, and thus have no meaningful model that can be presented and understood by a content creation user by means of a universal user interface. The present system forces the content creator to think about the relationship between the content of the originating link (parent node), the current link (current node) and the next link (child node) as the user will be homing in on the content he/she is after. This is of great importance to enhance conversion rates, e.g. it avoids content perusers giving up on finding what they are looking for and offers an absolute ‘shortest path’ to information, so that they can make an informed decision, purchase a product or take some other action with a minimum of steps/clicks/commands.

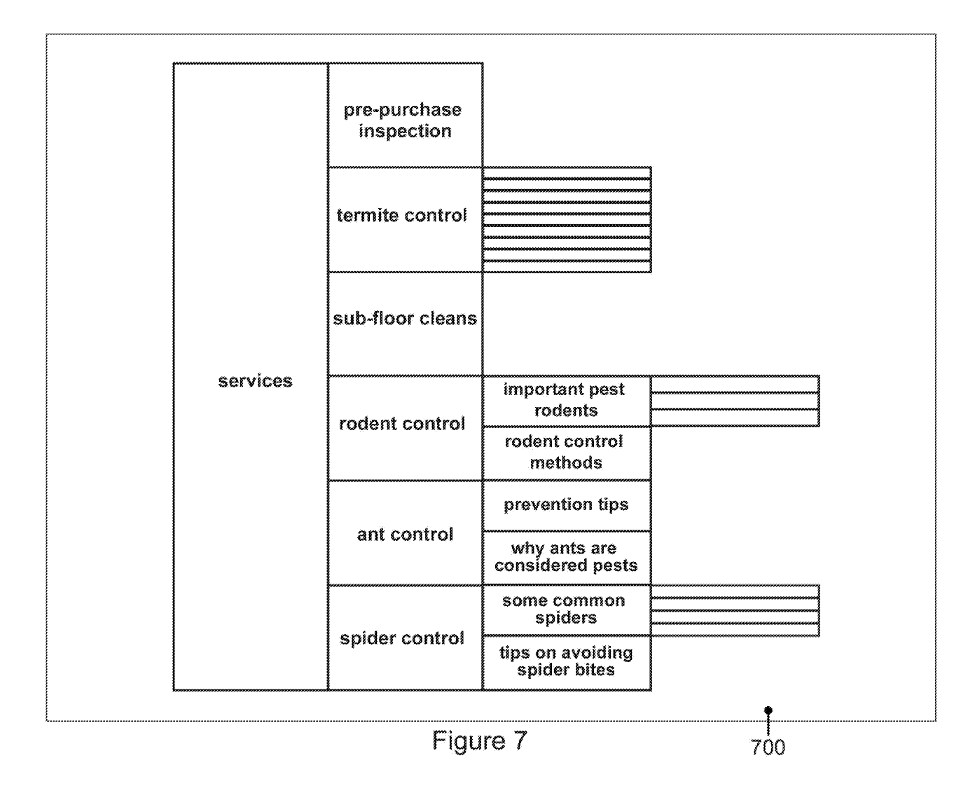

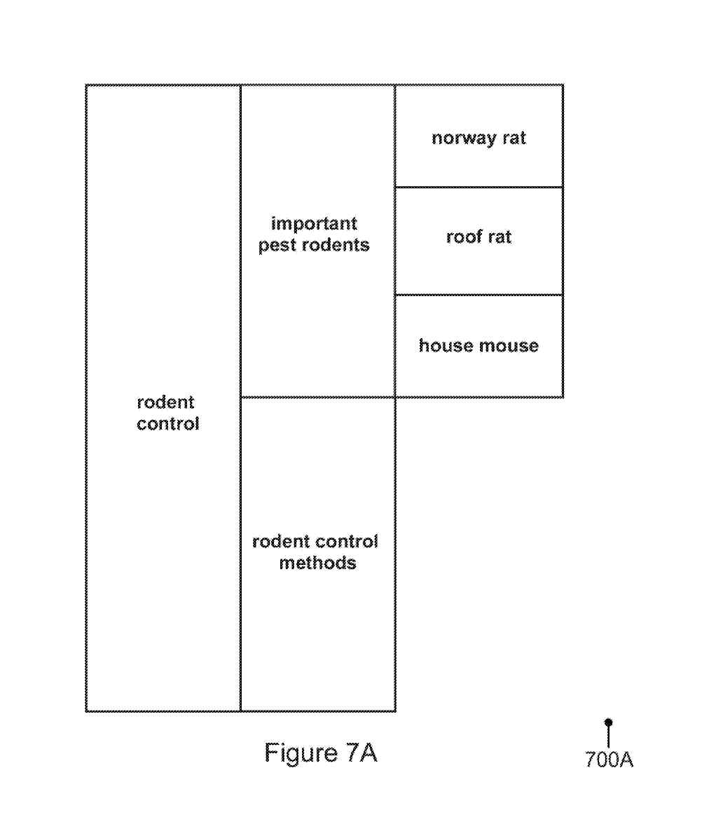

For content creation, one could for instance envision a user interface for editing content that is separated from form and function through displaying a tree in the form of the one in FIG. 7. The user would click through to the node in the hierarchy that he/she wishes to edit, with the clicked node zooming in until it becomes the new ‘parent’ in the clickable hierarchy. For example, selecting ‘rodent control’ in the interface depicted in FIG. 7, would yield a new state of the interface as depicted in FIG. 7A where new items, namely, ‘Norway rat’, ‘roof rat’ and ‘house mouse’, have now become visible.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors, programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A functional software product compliant with at least one predetermined computing platform adapted for cross-platform use comprising:
a predetermined form means for presenting content to a user of the product;
a predetermined function means for enabling the user of the product to navigate content, and;
at least one driver means operatively associated with the functional software product for enabling access to content by the predetermined form and function means wherein the driver means is adapted for accessing at least one originating content data resource having a format non-specific to the predetermined computing platform.

2. A functional software product as claimed in claim 1 wherein the at least one driver means comprises:
translation means for translating platform specific data access requests of the functional software product into platform independent data access requests.

3. A functional software product as claimed in claim 2 wherein the platform specific data access requests and the platform independent data access requests comprise one or a combination of:
read requests;
write requests.

4. A functional software product as claimed in claim 1, wherein the at least one driver means is adapted to expose one or more aggregated archives of originating content data resources to the predetermined form and function means to search each archive for an associated URI of the archive resource to be retrieved.

5. A functional software product as claimed in claim 1, wherein the at least one driver means resides within an application level of the software product.

6.-15. (canceled)

16. A method for handling digital content on a plurality of predetermined computing platforms comprising the steps of:
presenting content to a user of a functional software product compliant with a first predetermined computing platform and enabling the user of the product to navigate content within a data processing system;
accessing at least one originating content data resource having a format nonspecific to the first predetermined computing platform.

17. A method as claimed in claim 16 further comprising the steps of:
union mounting the content of at least two or more data storage archives to produce an aggregate of content accessible to the user of the software product.

18.-28. (canceled)

29. Apparatus adapted to handle digital content on a plurality of predetermined computing platforms, said apparatus comprising: processor means adapted to operate in accordance with a predetermined instruction set, said apparatus, in conjunction with said instruction set, being adapted to perform the method as claimed in claim 16.

30. A computer program product comprising:
a non-transient computer usable medium having computer readable program code and computer readable system code embodied on said medium for handling digital content on a plurality of predetermined computing platforms within a data processing system, said computer program product including:
computer readable code within said computer usable medium for performing the method as claimed in claim 16.

31.-41. (canceled)

42. A system for handling digital content on a plurality of predetermined computing platforms, the system comprising:
a functional software product compliant with a first predetermined computing platform having computer readable program code and computer readable system code embodied on a non-transitory computer useable medium for presenting content to a user of the product and enabling the user of the product to navigate content within a data processing system; and
at least one driver means adapted for accessing at least one originating content data resource having a format non-specific to the first predetermined computing platform.

43. A system as claimed in claim 42 wherein the at least one driver means comprises translation means operatively associated with the functional software product for translating platform specific data access requests of the functional software product into platform independent data access requests.

44. A system as claimed in claim 42 wherein the content is contained in at least two or more data storage archives.

45. A system as claimed in claim 44 wherein the at least two or more data storage archives comprise a data file format that provides asymmetric performance in respect of reading and writing functions in which reading has precedence and priority.

46. A system as claimed in claim 44 wherein the at least two or more data storage archives are located on one or a combination of:
an Internet server;
CD-ROM;
RAM;
Smartphone resource bundle;
External hardrive.

47. A system as claimed in claim 44 further comprising:
union mounting means adapted to union mount the content of the at least two or more data storage archives to produce an aggregate of content accessible to the user of the software product.

48. A system as claimed in claim 47 further comprising at least one driver means adapted for writing to at least one of the at least two or more data storage archives.
